(19) United States
(12) Patent Application Publication
(10) Pub. No.: US 2006/0274229 A1
(43) Pub. Date: Dec. 7, 2006

(54) LIQUID CRYSTAL DISPLAY DEVICE

(76) Inventors: Hideki ITO, Fukaya-shi (JP); Akio MURAYAMA, Fukaya-shi (JP); Yuuzo HISATAKE, Fukaya-shi (JP); Chigusa TAGO, Fukaya-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/421,305

(22) Filed: May 31, 2006

(30) Foreign Application Priority Data
Jun. 1, 2005 (JP) 2005-161621
Jun. 1, 2005 (JP) 2005-161622
Jun. 1, 2005 (JP) 2005-161623

(51) Int. Cl. G02F 1/1335

(52) U.S. Cl. 349/96

(57) ABSTRACT

A liquid crystal display device includes a circular polarizer structure, a circular analyzer structure and a variable retarder structure. The circular polarizer structure includes a uniaxial third retardation plate with a refractive index anisotropy of nx≅ny<nz and a uniaxial fourth retardation plate with a refractive index anisotropy of nx>ny≅nz, which are disposed for optical compensation of the circular polarizer structure. The circular analyzer structure includes a uniaxial fifth retardation plate with a refractive index anisotropy of nx≅ny<nz and a uniaxial sixth retardation plate with a refractive index anisotropy of nx>ny≅nz, which are disposed for optical compensation of the circular analyzer structure. The variable retarder structure includes a uniaxial seventh retardation plate with a refractive index anisotropy of nx≅ny>nz, which is disposed for optical compensation of the variable retarder structure.

### CROSS-REFERENCE TO RELATED APPLICATIONS

This application is based upon and claims the benefit of priority from prior Japanese Patent Applications No. 2005-161621, filed Jun. 1, 2005; No. 2005-161622, filed Jun. 1, 2005; and No. 2005-161623, filed Jun. 1, 2005, the entire contents of all of which are incorporated herein by reference.

### BACKGROUND OF THE INVENTION

1. Field of the Invention

The present invention relates generally to a liquid crystal display device, and more particularly to a circular-polarization-based vertical-alignment-mode liquid crystal display device.

2. Description of the Related Art

In the field of display devices such as liquid crystal display devices, there has been an increasing demand for biaxial retardation plates (optical films) for compensating retardation of optical elements constituting the display device, with a view to improving viewing angle characteristics. The biaxial retardation plate can be obtained, for example, by biaxial-drawing a high-polymer film, but there arises such a problem that the manufacturing cost increases. In addition, the refractive index is controllable only in a limited range, and it is difficult to realize a desired refractive index ellipsoid. Moreover, the range of selection of material for obtaining biaxiality is narrow, and it is difficult to match the material with the wavelength dispersion characteristic of the refractive index of the liquid crystal (see, for instance, T. Ishinabe et al., A Wide Viewing Angle Polarizer and a Quarter-wave Plate with a Wide Wavelength Range for Extremely High Quality LCDs, IDW '01 Proceedings, p. 485 (2001), and Y. Iwamoto et al., Improvement of Display Performance of High Transmittance Photo-Aligned Multi-domain Vertical Alignment LCDs Using Circular Polarizers, IDW '02 Proceedings, p. 85 (2002)).

### BRIEF SUMMARY OF THE INVENTION

The present invention has been made in consideration of the above-described problems, and the object of the invention is to provide a liquid crystal display device that can improve viewing angle characteristics and can reduce cost.

According to a first aspect of the invention, there is provided a liquid crystal display device which is configured such that a dot-matrix liquid crystal cell, in which a liquid crystal layer is held between two electrode-equipped substrates, is disposed between a first polarizer plate that is situated on a light source side and a second polarizer plate that is situated on an observer side, a first retardation plate is disposed between the first polarizer plate and the liquid crystal cell such that a slow axis of the first retardation plate forms an angle of about 45° with respect to an absorption axis of the first polarizer plate, and a second retardation plate is disposed between the second polarizer plate and the liquid crystal cell such that a slow axis of the second retardation plate forms an angle of about 45° with respect to an absorption axis of the second polarizer plate, the liquid crystal display device comprising: a circular polarizer structure including the first polarizer plate and the first retardation plate; a variable retarder structure including the liquid crystal cell; and a circular analyzer structure including the second polarizer plate and the second retardation plate, wherein the variable retarder structure has an optically positive normal-directional phase difference in a black display state, each of the first retardation plate and the second retardation plate is a uniaxial ¼ wavelength plate which provides a phase difference of a ¼ wavelength between light rays of a predetermined wavelength that travel along a fast axis and the slow axis thereof, the circular polarizer structure includes a first optical compensation layer which is disposed for optical compensation of the circular polarizer structure between the first polarizer plate and the first retardation plate, the first optical compensation layer including a uniaxial third retardation plate with a refractive index anisotropy of nx≅ny<nz and a uniaxial fourth retardation plate with a refractive index anisotropy of nx>ny≅nz, the fourth retardation plate being disposed such that a slow axis of the fourth retardation plate is substantially perpendicular to the absorption axis of the first polarizer plate, the circular analyzer structure includes a second optical compensation layer which is disposed for optical compensation of the circular analyzer structure between the second polarizer plate and the second retardation plate, the second optical compensation layer including a uniaxial fifth retardation plate with a refractive index anisotropy of nx≅ny<nz and a uniaxial sixth retardation plate with a refractive index anisotropy of nx>ny≅nz, the sixth retardation plate being disposed such that a slow axis of the sixth retardation plate is substantially perpendicular to the absorption axis of the second polarizer plate and is substantially perpendicular to the slow axis of the fourth retardation plate, and the variable retarder structure includes a third optical compensation layer which is disposed for optical compensation of the variable retarder structure between the first retardation plate and the second retardation plate, the third optical compensation layer including a uniaxial seventh retardation plate with a refractive index anisotropy of nx≅ny>nz.

According to a second aspect of the invention, there is provided a liquid crystal display device which is configured such that a first retardation plate is disposed between a dot-matrix liquid crystal cell, in which a liquid crystal layer is held between two electrode-equipped substrates and a reflective layer is provided on each of pixels, and a polarizer plate such that a slow axis of the first retardation plate forms an angle of about 45° with respect to an absorption axis of the polarizer plate, the liquid crystal display device comprising: a circular polarizer/analyzer structure including the polarizer plate and the first retardation plate; and a variable retarder structure including the liquid crystal cell, wherein the variable retarder structure has an optically positive normal-directional phase difference in a black display state, the first retardation plate is a uniaxial ¼ wavelength plate which provides a phase difference of a ¼ wavelength between light rays of a predetermined wavelength that travel along a fast axis and the slow axis thereof, the circular polarizer/analyzer structure includes a first optical compensation layer which is disposed for optical compensation of the circular polarizer/analyzer structure between the polarizer plate and the first retardation plate, the first optical compensation layer including a uniaxial second retardation plate with a refractive index anisotropy of nx≅ny<nz and a uniaxial third retardation plate with a refractive index anisotropy of nx>ny≅nz, the third retardation plate being disposed such that a slow axis of the third retardation plate is substantially perpendicular to the absorption axis of the polarizer plate, and the variable retarder structure includes a second optical compensation layer which is disposed for optical compensation of the variable retarder structure between the first retardation plate and the liquid crystal cell, the second optical compensation layer including a fourth retardation plate with a refractive index anisotropy of nx≅ny>nz.

The present invention can provide a liquid crystal display device that can improve viewing angle characteristics and can reduce cost.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A schematically shows an example of the cross-sectional structure of a liquid crystal display device according to a first embodiment of the present invention;

FIG. 1B schematically shows an example of the cross-sectional structure of a liquid crystal display device according to a modification of the first embodiment of the invention;

FIG. 2 is a view for explaining a refractive index ellipsoid of a first retardation plate, a second retardation plate, a fourth retardation plate and a sixth retardation plate, which are applicable to the liquid crystal display device according to the embodiment;

FIG. 3 is a view for explaining a refractive index ellipsoid of a third retardation plate and a fifth retardation plate, which are applicable to the liquid crystal display device according to the embodiment;

FIG. 4 is a view for explaining a refractive index ellipsoid of a seventh retardation plate, which is applicable to the liquid crystal display device according to the embodiment;

FIG. 5 is a view for explaining a compensation principle of contrast/viewing angle characteristics of the liquid crystal display device according to the embodiment;

FIG. 6A schematically shows an example of the cross-sectional structure of a liquid crystal display device according to a second embodiment of the present invention;

FIG. 6B schematically shows an example of the cross-sectional structure of a liquid crystal display device according to Modification 1 of the second embodiment of the invention;

FIG. 6C schematically shows an example of the cross-sectional structure of a liquid crystal display device according to Modification 2 of the second embodiment of the invention;

FIG. 7A schematically shows an example of the cross-sectional structure of a liquid crystal display device according to a third embodiment of the present invention;

FIG. 7B schematically shows an example of the cross-sectional structure of a liquid crystal display device according to a modification of the third embodiment of the invention;

FIG. 8 shows a measurement result of isocontrast curves of a liquid crystal display device according to Example 1;

FIG. 9 schematically shows an example of the cross-sectional structure of a liquid crystal display device according to a fourth embodiment of the present invention;

FIG. 10A schematically shows an example of the cross-sectional structure of a liquid crystal display device according to a fifth embodiment of the present invention;

FIG. 10B schematically shows an example of the cross-sectional structure of a liquid crystal display device according to a modification of the fifth embodiment of the invention;

FIG. 11A schematically shows an example of the cross-sectional structure of a liquid crystal display device according to a sixth embodiment of the present invention;

FIG. 11B schematically shows an example of the cross-sectional structure of a liquid crystal display device according to Modification 1 of the sixth embodiment of the invention;

FIG. 11C schematically shows an example of the cross-sectional structure of a liquid crystal display device according to Modification 2 of the sixth embodiment of the invention;

FIG. 12A schematically shows an example of the cross-sectional structure of a liquid crystal display device according to a seventh embodiment of the present invention;

FIG. 12B schematically shows an example of the cross-sectional structure of a liquid crystal display device according to Modification 1 of the seventh embodiment of the invention;

FIG. 12C schematically shows an example of the cross-sectional structure of a liquid crystal display device according to Modification 2 of the seventh embodiment of the invention;

FIG. 13 shows a measurement result of isocontrast curves of a liquid crystal display device according to Example 2;

FIG. 14 schematically shows an example of the cross-sectional structure of a liquid crystal display device according to an eighth embodiment of the present invention;

FIG. 15 is a cross-sectional view that schematically shows another example of the structure of the optical film;

FIG. 16 is a cross-sectional view that schematically shows still another example of the structure of the optical film; and

FIG. 17 is a view for explaining how to consider the in-plane phase difference and normal-directional phase difference of the liquid crystal film.

### DETAILED DESCRIPTION OF THE INVENTION

A liquid crystal display device according to an embodiment of the present invention will now be described with reference to the accompanying drawings.

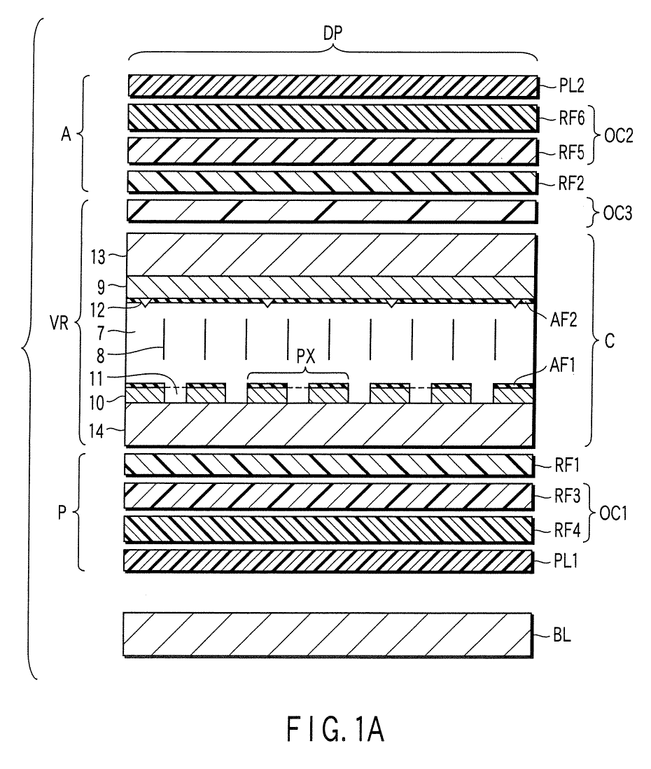

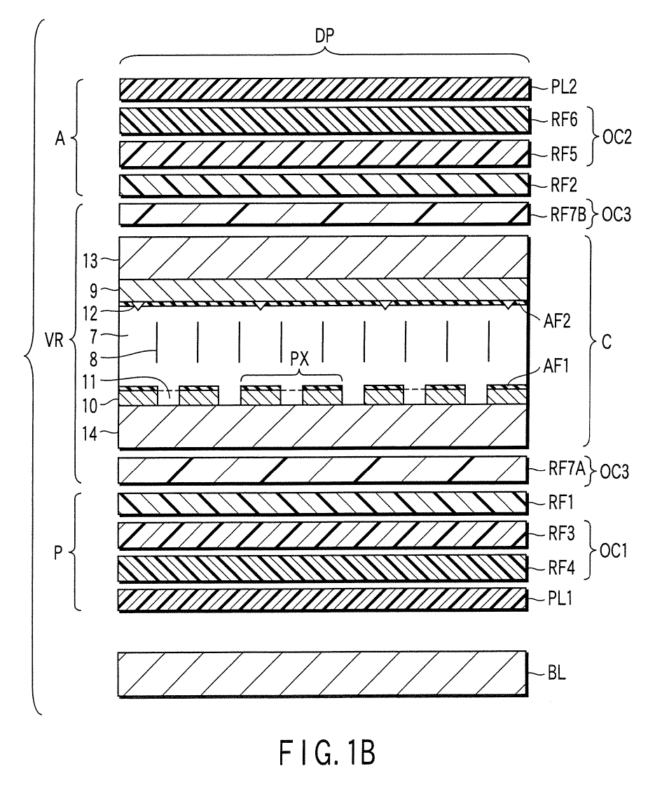

FIG. 1A schematically shows the structure of a liquid crystal display device according an embodiment of the invention. As is shown in FIG. 1A, the liquid crystal display device includes a liquid crystal cell of a circular-polarization-based vertical alignment mode in which liquid crystal molecules in each pixel are aligned substantially vertical to the major surface of the substrate in a voltage-off state. The liquid crystal display device comprises a circular polarizer structure P, a variable retarder structure VR and a circular analyzer structure A.

The variable retarder structure VR includes a dot-matrix liquid crystal cell C in which a liquid crystal layer is held two electrode-equipped substrates. Specifically, this liquid crystal cell C is an MVA mode liquid crystal cell, and a liquid crystal layer 7 is sandwiched between an active matrix substrate 14 and a counter-substrate 13. The gap between the active matrix substrate 14 and counter-substrate 13 is kept constant by a spacer (not shown). The liquid crystal cell C includes a display region DP for displaying an image. The display region DP is composed of pixels PX that are arranged in a matrix.

The active matrix substrate 14 is formed using an insulating substrate with light transmissivity, such as a glass substrate. One major surface of the active matrix substrate 14 is provided with, e.g. various lines such as scan lines and signal lines, and switching elements provided near intersections of the scan lines and signal lines. A description of these elements is omitted since they are not related to the operation of the present invention. Pixel electrodes 10 are provided on the active matrix substrate 14 in association with the respective pixels PX. The surfaces of the pixel electrodes 10 are covered with an alignment film AF1.

The various lines, such as scan lines and signal lines, are formed of aluminum, molybdenum, copper, etc. The switching element is a thin-film transistor (TFT) including a semiconductor layer of, e.g. amorphous silicon or polysilicon, and a metal layer of, e.g. aluminum, molybdenum, chromium, copper or tantalum. The switching element is connected to the scan line, signal line and pixel electrode 10. On the active matrix substrate 14 with this structure, a voltage can selectively be applied to a desired one of the pixel electrodes 10.

The pixel electrode 10 is formed of an electrically conductive material with light transmissivity, such as indium tin oxide (ITO). The pixel electrode 10 is formed by providing a thin film using, e.g. sputtering, and then patterning the thin film using a photolithography technique and an etching technique.

The alignment film AF1 is formed of a thin film of a resin material with light transmissivity, such as polyimide. In this embodiment, the alignment film AF1 is not subjected to a rubbing process, and liquid crystal molecules 8 are vertically aligned.

The counter-substrate 13 is formed using an insulating substrate with light transmissivity, such as a glass substrate. A common electrode 9 is provided on one major surface of the counter-substrate 13. The surface of the common electrode 9 is covered with an alignment film AF2.

The common electrode 9, like the pixel electrode 10, is formed of an electrically conductive material with light transmissivity, such as ITO. The alignment film AF2, like the alignment film AF1 on the active matrix substrate 14, is formed of a resin material with light transmissivity, such as polyimide. In this embodiment, the common electrode 9 is formed as a planar continuous film that faces all the pixel electrodes with no discontinuity.

When the present display device is constructed as a color liquid crystal device, the liquid crystal cell C includes color filter layers. The color filter layers are color layers of, e.g. three colors of blue, green and red. The color filter may be provided between the insulating substrate of the active matrix substrate 14 and the pixel electrode 10 with a COA (Color-filter On Array) structure, or may be provided on the counter-substrate 13.

If the COA structure is adopted, the color filter layer is provided with a contact hole, and the pixel electrode 10 is connected to the switching element via the contact hole. The COA structure is advantageous in that high-precision alignment using, e.g. alignment marks is needless when the liquid crystal cell C is to be formed by attaching the active matrix substrate 14 and counter-substrate 13.

The circular polarizer structure P includes a first polarizer plate PL1 that is located on a light source side of the liquid crystal cell C, that is, on a backlight unit BL side, and a uniaxial first retardation plate RF1 that is disposed between the first polarizer plate PL1 and liquid crystal cell C. The circular analyzer structure A includes a second polarizer plate PL2 that is disposed on the observation surface side of the liquid crystal cell C, and a uniaxial second retardation plate RF2 that is disposed between the second polarizer plate PL2 and liquid crystal cell C.

Each of the first polarizer plate PL1 and second polarizer plate PL2 has a transmission axis and an absorption axis, which are substantially perpendicular to each other in the plane thereof. The first retardation plate PL1 and second retardation plate PL2 are disposed such that their transmission axes intersect at right angles with each other. Each of the first polarizer plate PL1 and second polarizer plate PL2 is configured such that a polarizer formed of, e.g. polyvinyl alcohol is held between base films of, e.g. triacetate cellulose (TAC).

Each of the first retardation plate RF1 and second retardation plate RF2 is a uniaxial ¼ wavelength plate that has, within its plane, a fast axis and a slow axis, which are substantially perpendicular to each other, and provides a phase difference of ¼ wavelength (i.e. in-plane phase difference of 140 nm) between light rays with a predetermined wavelength (e.g. 550 nm), which pass through the fast axis and slow axis. The first retardation plate RF1 and second retardation plate RF2 are disposed such that their slow axes intersect at right angles with each other. The first retardation plate RF1 is disposed such that its slow axis forms an angle of about 45° with respect to the absorption axis of the first polarizer plate PL1. Similarly, the second retardation plate RF2 is disposed such that its slow axis forms an angle of about 45° with respect to the absorption axis of the second polarizer plate PL2.

The liquid crystal display device with this structure, which includes, in particular, a transmission part that can pass backlight in at least a part of the pixel PX or in at least a part of the display region DP, is constructed by successively stacking the backlight unit BL, circular polarizer structure P, variable retarder structure VR and circular analyzer structure A.

The liquid crystal display device with this structure includes a first optical compensation layer OC1, which is disposed for optical compensation of the circular polarizer structure P (including the base films of the first polarizer plate PL1) between the first polarizer plate PL1 and first retardation plate RF1; a second optical compensation layer OC2, which is disposed for optical compensation of the circular analyzer structure A (including the base films of the second polarizer plate PL2) between the second polarizer plate PL2 and second retardation plate RF2; and a third optical compensation layer OC3, which is disposed for optical compensation of the variable retarder structure VR between the first retardation plate RF1 and second retardation plate RF2.

Specifically, the first optical compensation layer OC1 is provided in the circular polarizer structure P, and includes at least an optically uniaxial third retardation plate (positive C-plate) RF3 which has a refractive index anisotropy of nx≅ny<nz, and an optically uniaxial fourth retardation plate (positive A-plate) RF4 which has a refractive index anisotropy of nx>ny≅nz. The fourth retardation plate RF4 is disposed such that its slow axis is substantially perpendicular to the absorption axis of the first polarizer plate PL1. Thereby, the first optical compensation layer OC1 compensates the viewing angle characteristics of the circular polarizer structure P so that emission light from the circular polarizer structure P may become substantially circularly polarized light, regardless of the direction of emission.

The second optical compensation layer OC2 is provided in the circular analyzer structure A, and includes at least an optically uniaxial fifth retardation plate (positive C-plate) RF5 which has a refractive index anisotropy of nx≅ny<nz, and an optically uniaxial sixth retardation plate (positive A-plate) RF6 which has a refractive index anisotropy of nx>ny≅nz. The sixth retardation plate RF6 is disposed such that its slow axis is substantially perpendicular to the absorption axis of the second polarizer plate PL2 and substantially perpendicular to the slow axis of the fourth retardation plate RF4. Thereby, the second optical compensation layer OC2 compensates the viewing angle characteristics of the circular analyzer structure A so that emission light from the circular analyzer structure A may become substantially circularly polarized light, regardless of the direction of emission.

The third optical compensation layer OC3 is provided in the variable retarder structure VR, and includes an optically uniaxial seventh retardation plate (negative C-plate) RF7 which has a refractive index anisotropy of nx≅ny>nz. In the example shown in FIG. 1A, the seventh retardation plate RF7 is disposed between the liquid crystal cell C and the second retardation plate RF2. Alternatively, the seventh retardation plate RF7 may be disposed between the liquid crystal cell C and the first retardation plate RF1. Thereby, the third optical compensation layer OC3 compensates the viewing angle characteristics of the phase difference of the liquid crystal cell C in the variable retarder structure VR (i.e. an optically positive normal-directional phase difference of the liquid crystal layer 7 in the state in which the liquid crystal molecules 8 are aligned substantially vertical to the major surface of the substrate, that is, in the state of black display).

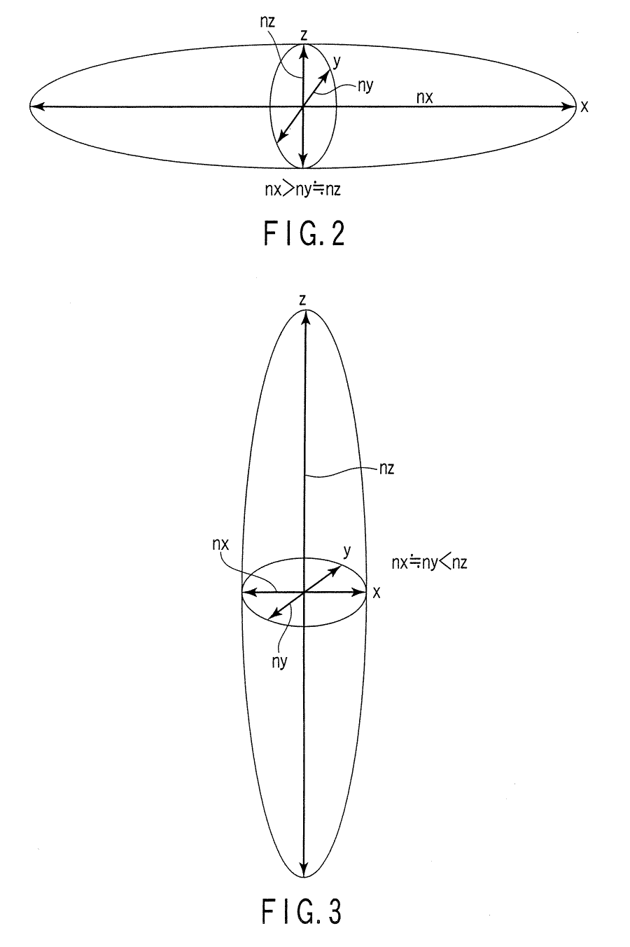

A retardation plate that is applicable to the first retardation plate RF1, second retardation plate RF2, fourth retardation plate RF4 and sixth retardation plate RF6 should have a refractive index anisotropy (nx>ny=nz) as shown in FIG. 2. Each of the fourth retardation plate RF4 and sixth retardation plate RF6 has an in-plane phase difference of, e.g. 50 nm.

A retardation plate that is applicable to the third retardation plate RF3 and fifth retardation plate RF5 should have a refractive index anisotropy (nx≅ny<nz) as shown in FIG. 3. Each of the third retardation plate RF3 and fifth retardation plate RF5 has a normal-directional phase difference of, e.g. 100 nm.

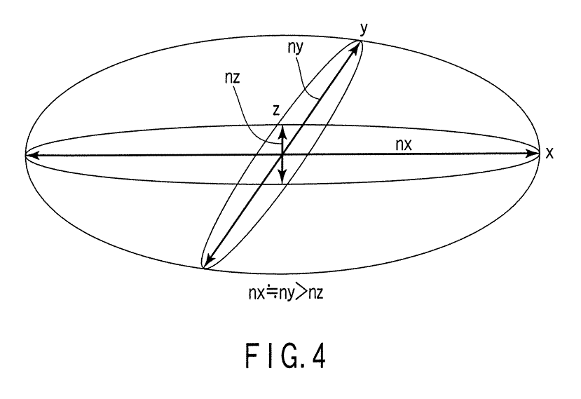

A retardation plate that is applicable to the seventh retardation plate RF7 should have a refractive index anisotropy (nx≅ny>nz) as shown in FIG. 4. The seventh retardation plate RF7 has a normal-directional phase difference of, e.g. −220 nm. In FIG. 2 to FIG. 4, nx and ny designate refractive indices in two mutually perpendicular directions (X axis and Y axis) in the major surface of each retardation plate, and nz indicates the refractive index in the normal direction (Z axis) to the major surface of the retardation plate.

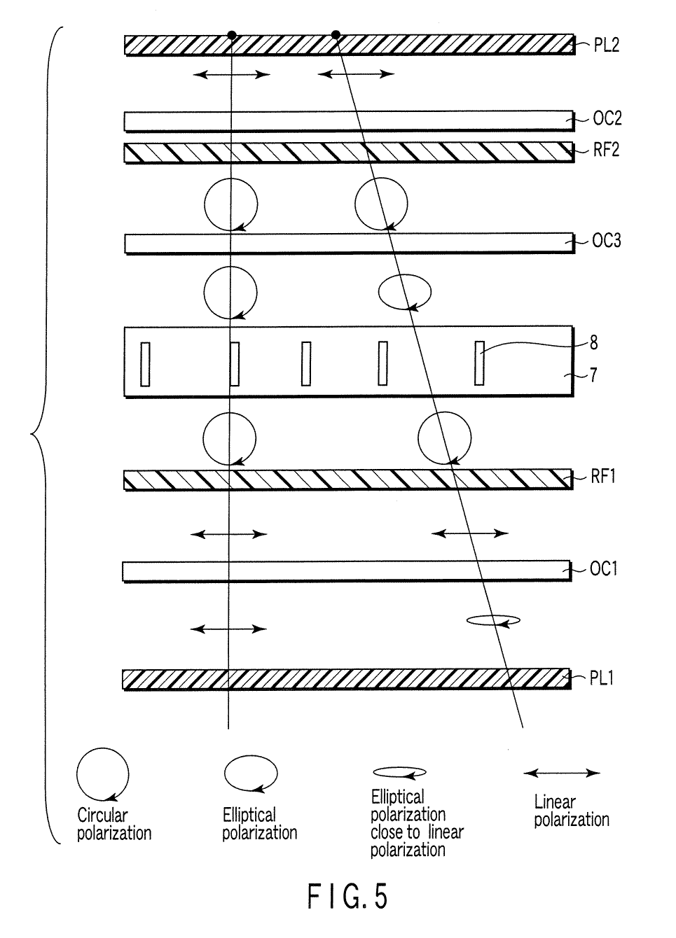

FIG. 5 is a conceptual view of the polarization state in respective optical paths, illustrating the optical principle of the viewing angle characteristics of the liquid crystal display device shown in FIG. 1A.

The liquid crystal display device uses the third optical compensation layer OC3 including the optically negative seventh retardation plate RF7, which is made to function as a negative retardation plate along with the separately provided first retardation plate RF1 and second retardation plate RF2. Thereby, the viewing angle dependency of the optically positive phase difference (normal-directional phase difference) in the normal direction of the liquid crystal layer 7, whose Δn·d is 280 nm or more, is compensated. The third optical compensation layer OC3 with this compensation function is provided between the first retardation plate RF1 and second retardation plate RF2. Thus, if light that is incident on the first retardation plate RF1 and second retardation plate RF2 is linearly polarized light, the light that is emitted from the first retardation plate RF1 and second retardation plate RF2 becomes substantially circularly polarized light, regardless of the emission angle or emission direction.

Accordingly, in the case where the third optical compensation layer OC3 is situated between the liquid crystal layer 7 and second retardation plate RF2, the light that is incident on the liquid crystal layer 7 becomes circularly polarized light, irrespective of the incidence angle or incidence direction. Even if the circularly polarized light becomes elliptically polarized light due to the normal-directional phase difference of the liquid crystal layer 7, the elliptically polarized light is restored to the circularly polarized light by the function of the third optical compensation layer OC3. Thus, the light that is incident on the second retardation plate RF2 disposed on the third optical compensation layer OC3 becomes circularly polarized light, irrespective of the incidence angle or incidence direction. Therefore, good display characteristics can be obtained regardless of the viewing direction.

In the case where the third optical compensation layer OC3 is situated between the liquid crystal layer 7 and first retardation plate RF1, the light that is incident on the third optical compensation layer OC3 becomes circularly polarized light, irrespective of the incidence angle or incidence direction. Even if the circularly polarized light becomes elliptically polarized light due to the normal-directional phase difference of the third optical compensation layer OC3, the elliptically polarized light is restored to the circularly polarized light by the function of the liquid crystal layer 7. Thus, the light that is incident on the second retardation plate RF2 disposed on the liquid crystal layer 7 becomes circularly polarized light, irrespective of the incidence angle or incidence direction. Therefore, good display characteristics can be obtained irrespective of the viewing direction, as in the case where the third optical compensation layer OC3 is disposed between the liquid crystal layer 7 and second retardation plate RF2.

As has been described above, in the liquid crystal display device structure of this embodiment, polarized light, which is incident on the liquid crystal layer 7 and third optical compensation layer OC3 that compensates the normal-directional phase difference of the liquid crystal layer 7, is circularly polarized light which has no directional polarity. Therefore, the compensation effect, which does not depend on the direction of alignment of liquid crystal molecules, can be obtained.

In order to sufficiently obtain the above-described advantageous effect, the first optical compensation layer OCG, which comprises such optically uniaxial retardation plates as to compensate the viewing-angle characteristics of the first retardation plate RF1 and first polarizer plate PL1, may be disposed between the first retardation plate RF1 and first polarizer plate PL1, which are located on the light source side (incidence side). In addition, the second optical compensation layer OC2, which comprises such optically uniaxial retardation plates as to compensate the viewing-angle characteristics of the second retardation plate RF2 and second polarizer plate PL2, may be disposed between the second retardation plate RF2 and second polarizer plate PL2, which are located on the observer side (emission side). Thereby, better viewing-angle characteristics can be obtained.

If biaxial retardation plates are used, viewing-angle characteristics can be improved. However, in the structure of the present embodiment, the uniaxial first retardation plate (¼ wavelength plate) RF1 is combined with the third retardation plate RF3 and fourth retardation plate RF4 which are included in the first optical compensation layer OC1. Thereby, substantially the same function as the function of the biaxial retardation plate, which can improve viewing-angle characteristics, can be obtained. Similarly, the uniaxial second retardation plate (¼ wavelength plate) RF2 is combined with the fifth retardation plate RF5 and sixth retardation plate RF6 which are included in the second optical compensation layer OC2. Thereby, substantially the same function as the function of the biaxial retardation plate, which can improve viewing-angle characteristics, can be obtained. Thus, the viewing-angle characteristics can be improved and the manufacturing cost can be made lower than in the case of using the biaxial retardation plate.

In the liquid crystal display device of the above-described embodiment, the multi-domain vertical alignment (MVA) mode, in which liquid crystal molecules in the pixel are controlled and oriented in at least two directions in a voltage-on state, is applied to the liquid crystal cell C. In the MVA mode, it is preferable to form such a domain that the orientation direction of liquid crystal molecules 8 in the pixel PX in a voltage-on state is substantially parallel to the absorption axis or transmission axis of the first polarizer plate PL1 in at least half the opening region of each pixel PX.

This orientation control can be realized by providing a protrusion 12 for forming the multi-domain structure in the pixel PX, as shown in FIG. 1A. The orientation control can also be realized by forming a slit 11 for forming the multi-domain structure in at least one of the pixel electrode 10 and counter-electrode 9 which are disposed in each pixel PX. Further, the orientation control can be realized by providing alignment films AF1 and AF2, which are subjected to an orientation process of, e.g. rubbing, for forming the multi-domain structure, on those surfaces of the active matrix substrate 14 and counter-substrate 13, which sandwich the liquid crystal layer 7. Needless to say, at least two of the protrusion 12, slit 11 and orientation film AF1, AF2 that is subjected to the orientation process may be combined.

In the case of the circular-polarization-based MVA mode liquid crystal display device, the transmittance does not depend on the liquid crystal molecule orientation direction in the pixel in the voltage-on state. Thus, if a phase difference of ½ wavelength is obtained by the liquid crystal layer 7 and seventh retardation plate RF7, excellent transmittance characteristics can be obtained regardless of the liquid crystal molecule orientation direction.

In the MVA mode, the multi-domain structure is constituted in each pixel so as to obtain the above-mentioned phase difference of ½ wavelength regardless of the light incidence angle. However, depending on the incidence angle or the tilt angle of liquid crystal molecules, there may be a case where the orientation dependence of phase difference cannot be compensated by the multi-domain effect. In order to minimize this problem, the liquid crystal molecule orientation direction should be made parallel to the transmission axis or absorption axis of the polarizer plate. The reason is that when the light that emerges from the liquid crystal layer 7 and seventh retardation plate RF7 becomes elliptically polarized light, and not circularly polarized light, the major-axis direction of the elliptically polarized light becomes parallel to the optical axis (transmission axis and absorption axis) of the second polarizer plate PL2 that is the analyzer.

Preferably, in the liquid crystal display device according to the present embodiment, the first retardation plate RF1, the second retardation plate RF2, the fourth retardation plate RF4 and the sixth retardation plate RF6 should be formed of a resin that has a retardation value, which hardly depends on an incidence light wavelength in a plane thereof, such as ARTON resin, polyvinyl alcohol resin, ZEONOR resin, or triacetyl cellulose resin. Alternatively, the first retardation plate RF1, second retardation plate RF2, fourth retardation plate RF4 and sixth retardation plate RF6 should preferably be formed of a resin that has a retardation value, which is about ¼ of incident light wavelength in a plane thereof regardless of incident light wavelength, such as denatured polycarbonate resin. Polarization with less wavelength dispersion dependency of incident light can be obtained by using, not a material such as polycarbonate which has a greater retardation in the shorter-wavelength side, but a material with a constant refractive index in all wavelength ranges or a material such as denatured polycarbonate which always has a retardation value of ¼ wavelength regardless of incident light wavelength.

The third retardation plate RF3 and fifth retardation plate RF5 should preferably be formed of a nematic liquid crystal polymer having a normal-directional optical axis. It is difficult to form a film with a positive phase difference in the normal direction by a conventional drawing technique. The formation is made easier by using a nematic liquid crystal polymer or a discotic liquid crystal polymer, which has a normal-directional optical axis, and the cost can be reduced.

The seventh retardation plate RF7 should preferably be formed of one of a chiral nematic liquid crystal polymer, a cholesteric liquid crystal polymer and a discotic liquid crystal polymer.

In the present embodiment, as described above, the seventh retardation plate RF7 is employed in order to compensate the normal-directional phase difference of the liquid crystal layer 7. The phase difference of the liquid crystal layer 7, which is to be compensated, has wavelength dispersion. In order to compensate the phase difference of the liquid crystal layer 7 including the wavelength dispersion, a more excellent compensation effect can be obtained if the seventh retardation plate RF7 has similar wavelength dispersion. It is thus preferable to form the seventh retardation plate RF7 of the above-mentioned liquid crystal polymer.

### Modification of the First Embodiment

In a modification of the first embodiment, the liquid crystal display device may include a third optical compensation layer OC3 which is divided into two segments with separated functions. Specifically, as shown in FIG. 1B, the seventh retardation plate RF7, which constitutes the third optical compensation layer OC3, is functionally divided into a first segment layer RF7A, which is disposed between the first retardation plate RF1 and the liquid crystal cell C, and a second segment layer RF7B, which is disposed between the second retardation plate RF2 and the liquid crystal cell C. In this structure, the total thickness of the first segment layer RF7A and second segment layer RF7B is set to be, for instance, T, which is the thickness of the functional layer that functions as the seventh retardation plate RF7. Thereby, the same function as with the liquid crystal display device shown in FIG. 1A is realized. For example, if the seventh retardation plate RF7 needs to have a normal-directional phase difference of −220 nm, each of the first segment layer RF7A and second segment layer RF7B is configured to have a normal-directional phase difference of −110 nm.

### Second Embodiment

In a liquid crystal display device according to a second embodiment of the invention, at least one of the first optical compensation layer OC1 and second optical compensation layer OC2 is composed of a single optical film in which two liquid crystal films are stacked. In each of the two liquid crystal films, liquid crystal polymer molecules, which exhibit positive uniaxiality in the major plane of the film, are nematic-hybrid-aligned along the normal direction.

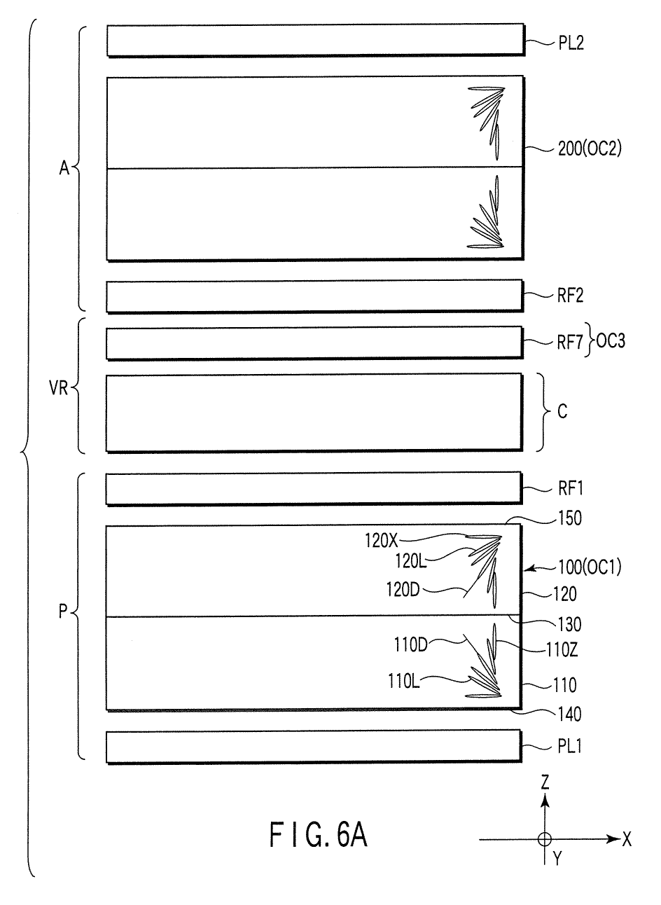

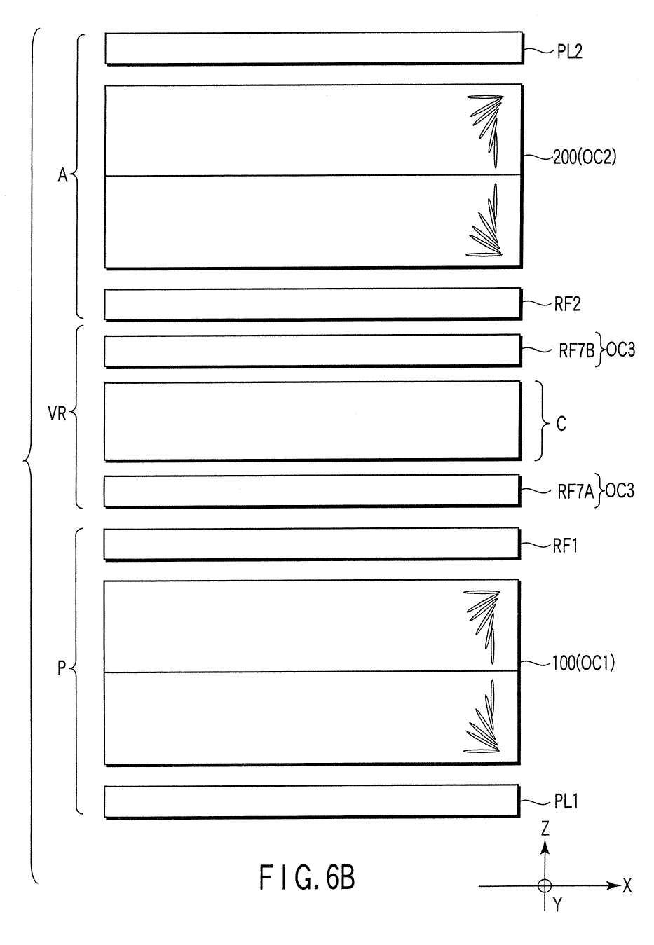

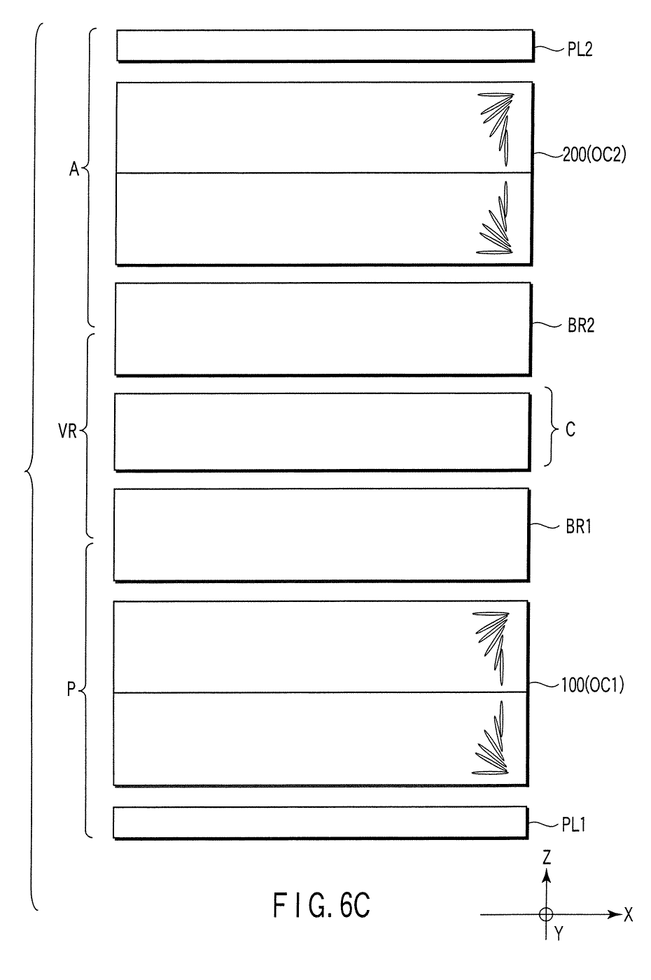

FIG. 6A schematically shows the structure of the liquid crystal display device according to the second embodiment of the invention. As shown in FIG. 6A, the liquid crystal display device is a liquid crystal display device of a circular-polarization-based vertical alignment mode in which liquid crystal molecules in each pixel are aligned substantially vertical to the major surface of the substrate in a voltage-off state. The liquid crystal display device comprises a circular polarizer structure P, a variable retarder structure VR and a circular analyzer structure A. The structural elements common to those in the first embodiment are denoted by like reference numerals, and a detailed description is omitted.

The first optical compensation layer OC1 is composed of a single optical film 100. The optical film 100 has an optical function equivalent to the total refractive index anisotropy of the third retardation plate and fourth retardation plate, which have been described in the first embodiment. In short, in the second embodiment the third retardation plate RF3 and fourth retardation plate RF4 in the first embodiment are replaced with the single optical film 100.

Similarly, the second optical compensation layer OC2 is composed of a single optical film 200. The optical film 200 has an optical function equivalent to the total refractive index anisotropy of the fifth retardation plate and sixth retardation plate, which have been described in the first embodiment. In short, in the second embodiment the fifth retardation plate RF5 and sixth retardation plate RF6 in the first embodiment are replaced with the single optical film 200.

Since the optical films 100 and 200 have substantially the same structure, the structure of the optical film 100 is described here in detail. Specifically, as shown in FIG. 6A, the optical film 100 comprises a first liquid crystal film 110 and a second liquid crystal film 120 which is stacked on the first liquid crystal film 110. The first liquid crystal film 110 is disposed on the outer side (i.e. the first polarizer plate PL1 side of the optical film 100). The second liquid crystal film 120 is disposed on the inner side (i.e. the first retardation plate RF1 side of the optical film 100).

Each of the first liquid crystal film 110 and second liquid crystal film 120 includes liquid crystal polymer molecules which exhibit positive uniaxiality in the major plane of the film. The liquid crystal polymer molecules included in the first liquid crystal film 110 and second liquid crystal film 120 are fixed in the state in which the liquid crystal polymer molecules are nematic-hybrid-aligned along the normal direction in the liquid crystal state.

The major plane, in this context, refers to a plane in which each liquid crystal film extends, and the major plane is defined an X axis and a Y axis which are perpendicular to each other. The normal direction refers to a direction normal to the major plane, and is defined by a Z axis that intersects the X axis and Y axis at right angles.

In the optical film 100, directors 110D and 120D of the liquid crystal polymer molecules 110L and 120L in the first liquid crystal film 110 and second liquid crystal film 120 are parallel in the major plane and perpendicular to each other in a cross-sectional plane extending in the normal direction. In addition, the directors 110D and 120D of the liquid crystal polymer molecules 110L and 120L in the first liquid crystal film 110 and second liquid crystal film 120 are symmetric with respect to a bonding interface 130 between the first liquid crystal film 110 and second liquid crystal film 120.

Specifically, in the major plane defined by the X axis and Y axis, the liquid crystal polymer molecules 110L included in the first liquid crystal film 110 are not twisted and the director 110D of the liquid crystal polymer molecules 110L is oriented in one direction when the liquid crystal polymer molecules 110L are orthogonally projected. When it is assumed that the director 110D of the liquid crystal polymer molecules 110L is substantially parallel to the X axis, the liquid crystal polymer molecules 110L are, in the cross section defined by the X axis and Z axis, substantially perpendicular to the bonding interface 130 in the vicinity of the bonding interface 130 and are substantially parallel to the bonding interface 130 in the vicinity of an outer surface 140 of the first liquid crystal film 110. In other words, in the first liquid crystal film 110, the liquid crystal polymer molecules 110L are distributed along the normal direction Z such that the angle (tilt angle) between their director 110D and the bonding interface 130 falls within the range between 0° and 90°.

Similarly, in the major plane defined by the X axis and Y axis, the liquid crystal polymer molecules 120L included in the second liquid crystal film 120 are not twisted and the director 120D of the liquid crystal polymer molecules 120L is oriented in one direction when the liquid crystal polymer molecules 120L are orthogonally projected. At this time, the second liquid crystal film 120 is disposed such that the director 120D of the liquid crystal polymer molecules 120L is substantially parallel to the X axis. In other words, the director 110D of the liquid crystal polymer molecules 110L and the director 120D of the liquid crystal polymer molecules 120L are parallel in the major plane.

In addition, in the cross section defined by the X axis and Z axis, the liquid crystal polymer molecules 120L are substantially perpendicular to the bonding interface 130 in the vicinity of the bonding interface 130 and are substantially parallel to the bonding interface 130 in the vicinity of an outer surface 150 of the second liquid crystal film 120. In other words, in the second liquid crystal film 120, too, the liquid crystal polymer molecules 120L are distributed along the normal direction Z such that the angle (tilt angle) between their director 120D and the bonding interface 130 falls within the range between 0° and 90°.

Thus, the second liquid crystal film 120 includes the liquid crystal polymer molecules 120L having the director 120D which intersects at right angles with the director 110D of the liquid crystal polymer molecules 110L included in the first liquid crystal film 110 in the cross section defined by the X axis and Z axis. In FIG. 6A, for example, the tilt angle of a liquid crystal polymer molecule 110Z included in the first liquid crystal film 110 is about 90° while the tilt angle of a liquid crystal polymer molecule 120X included in the second liquid crystal film 120 is about 0°, and the directors of these liquid crystal polymer molecules 110Z and 120X are perpendicular to each other. The same relationship applies to the other liquid crystal polymer molecules 110L and 120L included in the first liquid crystal film 110 and second liquid crystal film 120.

When the refractive index in the direction of the director 110D, 120D (i.e. direction parallel to the X axis) of the liquid crystal polymer molecule 110L, 120L is nx, the refractive index in the direction perpendicular to the direction of the director 110D, 120D (i.e. direction parallel to the Y axis) is ny and the refractive index in the normal direction (i.e. direction parallel to the Z axis) is nz, the optical film 100 has a refractive index anisotropy of nx=ny<nz in the vicinity of the bonding interface 130 and has a refractive index anisotropy of nx>ny=nz in the vicinity of the outer surfaces 140 and 150 of the first liquid crystal film 110 and second liquid crystal film 120.

Specifically, the first liquid crystal film 110 exhibits a refractive index anisotropy that is equivalent to a positive C-plate (nx=ny<nz) in the vicinity of the bonding interface 130, and a normal-directional phase difference is set at about 50 nm. Further, the first liquid crystal film 110 exhibits a refractive index anisotropy that is equivalent to a positive A-plate (nx>ny=nz) in the vicinity of the outer surface 140, and an in-plane phase difference is set at about 25 nm.

Similarly, the second liquid crystal film 120 exhibits a refractive index anisotropy that is equivalent to a positive C-plate (nx=ny<nz) in the vicinity of the bonding interface 130, and a normal-directional phase difference is set at about 50 nm. Further, the second liquid crystal film 120 exhibits a refractive index anisotropy that is equivalent to a positive A-plate (nx>ny=nz) in the vicinity of the outer surface 150, and an in-plane phase difference is set at about 25 nm.

Specifically, the optical film 100 has a normal-directional phase difference of about 100 nm in total, and has an in-plane phase difference of about 50 nm in total. The optical film 200 is similarly structured. In short, each of the optical films 100 and 200 has the function of a retardation plate with a positive normal-directional phase difference (e.g. 100 nm) in the normal direction, thereby to realize the function equivalent to the function of the third retardation plate RF3 and fifth retardation plate RF5. Further, each of the optical films 100 and 200 has the function of a retardation plate with a positive in-plane phase difference (e.g. 50 nm) in the major plane, thereby to realize the function equivalent to the function of the fourth retardation plate RF4 and sixth retardation plate RF6.

In the above-described second embodiment, in the optical film 100 functioning as the first optical compensation layer OC1, the director of the liquid crystal molecule that is aligned substantially horizontal to the film surface is so disposed as to intersect at right angles with the absorption axis of the first polarizer plate PL1. In addition, in the optical film 200 functioning as the second optical compensation layer OC2, the director of the liquid crystal molecule that is aligned substantially horizontal to the film surface is so disposed as to intersect at right angles with the absorption axis of the second polarizer plate PL2.

The optical films 100 and 200 are fabricated, for example, in the following manner. A base film is subjected, as needed, to an alignment process (e.g. formation of an alignment film, a rubbing process), and a liquid crystal material including positive uniaxial liquid crystal polymer molecules is coated on the base film. Thereby, the liquid crystal polymer molecules are hybrid-aligned along the normal direction of the base film at tilt angles in the range between about 0° and about 90° in the vicinity of the interface with the base film and at tilt angles in the range between about 90° and about 0° in the vicinity of the surface most away from the base film. In the hybrid-aligned state, the liquid crystal material is cured and the liquid crystal film is obtained.

The optical films 100 and 200 that are applicable to the second embodiment can be formed by preparing a first liquid crystal film and a second liquid crystal film each having a hybrid-aligned liquid crystal layer on a base film and bonding the surfaces of the liquid crystal layers. In this optical film, a bonding interface is formed between the surfaces of the liquid crystal layers.

According to the second embodiment with the above-described structure, the same function as with the first embodiment can be obtained and, moreover, the functions of a plurality of retardation plates can be realized by a single optical film. Thereby, the number of components can be reduced, the layer thickness of the device can be deceased, and the reduction in thickness of the device can advantageously be achieved. The above-described single optical film which has the functions of plural retardation plates can easily be formed even under a condition which is difficult to meet in the case of a biaxial drawn film. Moreover, the cost can be reduced.

### Modification 1 of the Second Embodiment

In Modification 1 of the second embodiment, the liquid crystal display device may include a third optical compensation layer OC3 which is divided into two segments with separated functions. Specifically, as shown in FIG. 6B, the seventh retardation plate RF7, which constitutes the third optical compensation layer OC3, is functionally divided, like the modification shown in FIG. 1B, into a first segment layer RF7A, which is disposed between the first retardation plate RF1 and the liquid crystal cell C, and a second segment layer RF7B, which is disposed between the second retardation plate RF2 and the liquid crystal cell C. With this structure, too, the same function as with the liquid crystal display device shown in FIG. 6A is realized.

### Modification 2 of the Second Embodiment

In Modification 2 of the second embodiment, which is a further modification of Modification 1 shown in FIG. 6B, the first segment layer RF7A and first retardation plate RF1 may be formed of a single biaxial retardation plate BR1, as shown in FIG. 6C. The single biaxial retardation plate BR1 has such a total optical function as to impart a phase difference of ¼ wavelength between light rays of a predetermined wavelength that pass through its fast axis and slow axis, and to be equivalent to a biaxial refractive index anisotropy of nx>ny>nz. The retardation plate BR1 is disposed between the liquid crystal cell C and optical film 100.

Similarly, the second segment layer RF7B and second retardation plate RF2 may be formed of a single biaxial retardation plate BR2. The single biaxial retardation plate BR2 has such a total optical function as to impart a phase difference of ¼ wavelength between light rays of a predetermined wavelength that pass through its fast axis and slow axis, and to be equivalent to a biaxial refractive index anisotropy of nx>ny>nz. The retardation plate BR2 is disposed between the liquid crystal cell C and optical film 200.

In order to realize the same function as the first retardation plate RF1 and second retardation plate RF2, each of the retardation plates BR1 and BR2 has a function of a ¼ wavelength plate which imparts a ¼ wavelength in-plane phase difference (140 nm) between light rays of a predetermined wavelength (e.g. 550 nm) that pass through its fast axis and slow axis in the major plane. In addition, in order to realize the same function as the first segment layer RF7A and second segment layer RF7B, each of the retardation plates BR1 and BR2 has a function of a retardation plate having a negative normal-directional phase difference (e.g. −110 nm) in the normal direction.

With this structure, too, the same function as that of the liquid crystal display device shown in FIG. 6A can be realized. Since the functions of a plurality of retardation plates can be realized by a single optical film, the number of components can be reduced, the layer thickness of the device can be deceased, and the reduction in thickness of the device can advantageously be achieved.

In the above-described second embodiment, in each of the structures shown in FIG. 6A to FIG. 6C, the first optical compensation layer OC1 is composed of the optical film 100 and the second optical compensation layer OC2 is composed of the optical film 200. Alternatively, only one of the first and second optical compensation layers OC1 and OC2 may be formed of the optical film, and the same function can be realized.

Similarly, in the structure shown in FIG. 6C, the first retardation plate RF1 and first segment RF7A are composed of the single biaxial retardation plate BR1, and the second retardation plate RF2 and second segment RF7B are composed of the single biaxial retardation plate BR2. Alternatively, only the first retardation plate RF1 and first segment RF7A, or the second retardation plate RF2 and second segment RF7B may be composed of the single biaxial retardation plate, and the same function can be realized.

### Third Embodiment

In a third embodiment of the invention, at least one of the combination of the first retardation plate RF1 and third retardation plate RF3 and the combination of the second retardation plate RF2 and fifth retardation plate RF5 in the first embodiment is composed of a single optical film in which two liquid crystal films are stacked. In each of the two liquid crystal films, liquid crystal polymer molecules, which exhibit positive uniaxiality in the major plane of the film, are nematic-hybrid-aligned along the normal direction. In the other respects, the structure of the third embodiment is the same as that of the first embodiment. The common structural elements are denoted by like reference numerals and a detailed description is omitted.

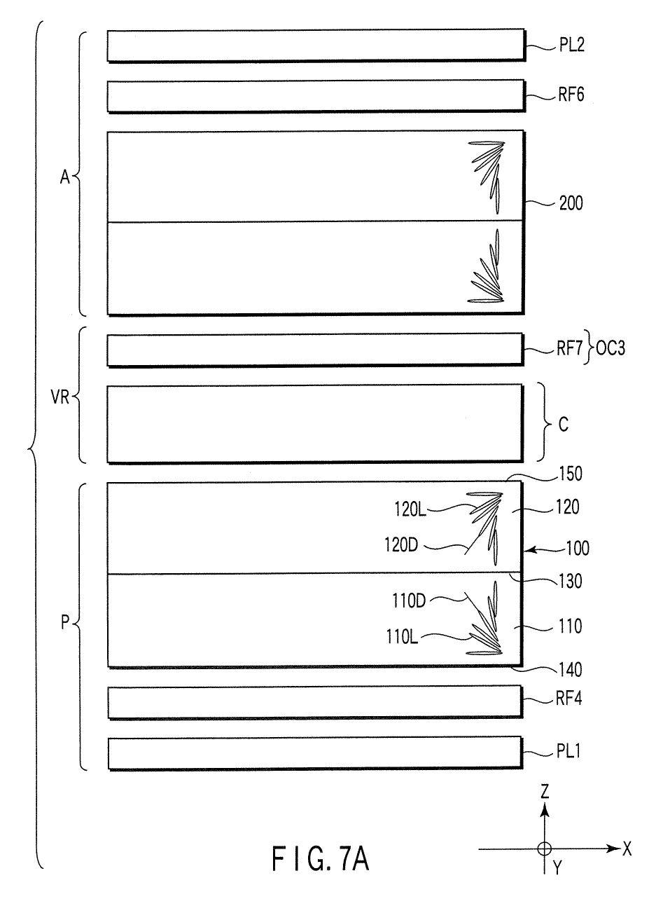

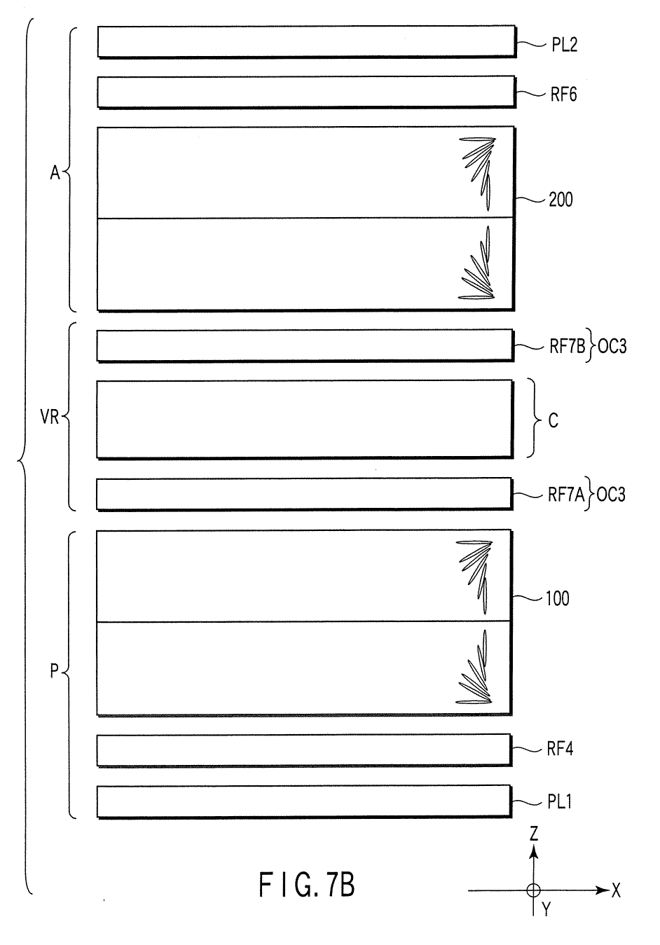

As is shown in FIG. 7A, the circular polarizer structure P includes a single optical film 100, a first polarizer plate PL1 and a fourth retardation plate RF4 that is disposed between the single optical film 100 and the first polarizer plate PL1. The optical film 100 has an optical function that is equivalent to a total refractive index anisotropy of the first retardation plate and third retardation plate described in the first embodiment. In short, in the third embodiment the first retardation plate RF1 and third retardation plate RF3 in the first embodiment are replaced with the single optical film 100.

Similarly, the circular analyzer structure A includes a single optical film 200, a second polarizer plate PL2 and a sixth retardation plate RF6 that is disposed between the single optical film 200 and the second polarizer plate PL2. The optical film 200 has an optical function that is equivalent to a total refractive index anisotropy of the second retardation plate and fifth retardation plate described in the first embodiment. In short, in the third embodiment the second retardation plate RF2 and fifth retardation plate RF5 in the first embodiment are replaced with the single optical film 200.

The detailed structures of the optical films 100 and 200 are as described in connection with the second embodiment.

When the refractive index in the direction of the director 110D, 120D (i.e. direction parallel to the X axis) of the liquid crystal polymer molecule 110L, 120L is nx, the refractive index in the direction perpendicular to the direction of the director 110D, 120D (i.e. direction parallel to the Y axis) is ny and the refractive index in the normal direction (i.e. direction parallel to the Z axis) is nz, the optical film 100 has a refractive index anisotropy of nx=ny<nz in the vicinity of the bonding interface 130 and has a refractive index anisotropy of nx>ny=nz in the vicinity of the outer surfaces 140 and 150 of the first liquid crystal film 110 and second liquid crystal film 120.

Specifically, the first liquid crystal film 110 exhibits a refractive index anisotropy that is equivalent to a positive C-plate (nx=ny<nz) in the vicinity of the bonding interface 130, and a normal-directional phase difference is set at about 50 nm. Further, the first liquid crystal film 110 exhibits a refractive index anisotropy that is equivalent to a positive A-plate (nx>ny=nz) in the vicinity of the outer surface 140, and an in-plane phase difference is set at about 70 nm.

Similarly, the second liquid crystal film 120 exhibits a refractive index anisotropy that is equivalent to a positive C-plate (nx=ny<nz) in the vicinity of the bonding interface 130, and a normal-directional phase difference is set at about 50 nm. Further, the second liquid crystal film 120 exhibits a refractive index anisotropy that is equivalent to a positive A-plate (nx>ny=nz) in the vicinity of the outer surface 150, and an in-plane phase difference is set at about 70 nm.

Specifically, the optical film 100 has a normal-directional phase difference of about 100 nm in total, and has an in-plane phase difference of about 140 nm in total. The optical film 200 is similarly structured. In short, in order to realize the same function as the first retardation plate RF1 and second retardation plate RF2, each of the optical films 100 and 200 has a function of a ¼ wavelength plate which imparts a ¼ wavelength in-plane phase difference (140 nm) between light rays of a predetermined wavelength (e.g. 550 nm) that pass through its fast axis and slow axis in the major plane. In addition, in order to realize the same function as the third retardation plate RF3 and fifth retardation plate RF5, each of the optical films 100 and 200 has a function of a retardation plate having a positive normal-directional phase difference (e.g. 100 nm) in the normal direction.

In the above-described third embodiment, in the optical film 100, the director of the liquid crystal molecule that is aligned substantially horizontal to the film surface is so disposed as to intersect at right angles with the absorption axis of the first polarizer plate PL1. In addition, in the optical film 200, the director of the liquid crystal molecule that is aligned substantially horizontal to the film surface is so disposed as to intersect at right angles with the absorption axis of the second polarizer plate PL2.

According to the third embodiment with the above-described structure, the same function as with the first embodiment can be obtained and, moreover, the functions of a plurality of retardation plates can be realized by a single optical film. Thereby, the number of components can be reduced, the layer thickness of the device can be deceased, and the reduction in thickness of the device can advantageously be achieved. The above-described single optical film which has the functions of plural retardation plates can easily be formed even under a condition which is difficult to meet in the case of a biaxial drawn film. Moreover, the manufacturing cost can be reduced.

### Modification of the Third Embodiment

In a modification of the third embodiment, the liquid crystal display device may include a third optical compensation layer OC3 which is divided into two segments with separated functions. Specifically, as shown in FIG. 7B, the seventh retardation plate RF7, which constitutes the third optical compensation layer OC3, is functionally divided, like the modification shown in FIG. 1B, into a first segment layer RF7A, which is disposed between the first retardation plate RF1 and the liquid crystal cell C, and a second segment layer RF7B, which is disposed between the second retardation plate RF2 and the liquid crystal cell C. With this structure, too, the same function as with the liquid crystal display device shown in FIG. 7A is realized.

In the above-described third embodiment, in each of the structures shown in FIG. 7A to FIG. 7B, the first retardation plate RF1 and third retardation plate RF3 are composed of the optical film 100, and the second retardation plate RF2 and fifth retardation plate RF5 are composed of the optical film 200. Alternatively, only the first retardation plate RF1 and third retardation plate RF3, or the second retardation plate RF2 and fifth retardation plate RF5 may be formed of the optical film, and the same function can be realized.

A specific example of the present invention will be described below. The principal structure of the example is the same as that of the first embodiment shown in FIG. 1A.

### EXAMPLE 1

In a liquid crystal display device according to Example 1, an F-based liquid crystal (manufactured by Merck Ltd.) was used as a nematic liquid crystal material with negative dielectric anisotropy for the liquid crystal layer 7. The refractive index anisotropy Δn of the liquid crystal material used in this case is 0.095 (wavelength for measurement=550 nm; in the description below, all refractive indices and phase differences of retardation plates are values measured at wavelength of 550 nm), and the thickness d of the liquid crystal layer 7 is 3.5 μm. Thus, the Δn·d of the liquid crystal layer 7 is 330 nm.

In Example 1, a uniaxial ¼ wavelength plate (in-plane phase difference=140 nm), which is formed of ZEONOR resin (manufactured by Nippon Zeon Co., Ltd.), is used as the first retardation plate RF1 and second retardation plate RF2. A vertical alignment film, which is formed of JALS214-R14 (manufactured by JSR), is provided on the surface (opposed to the polarizer plate) of the film that is used as the first retardation plate RF1. Subsequently, a nematic liquid crystal polymer (manufactured by Merck Ltd.) is coated. The refractive index anisotropy Δn of this liquid crystal polymer is 0.040, and the thickness d thereof is 2.5 μm. Thus, the normal-directional phase difference of the liquid crystal polymer is 100 nm. This liquid crystal polymer functions as the third retardation plate RF3. Further, a uniaxial retardation plate (in-plane phase difference=50 nm), which is formed of ZEONOR resin (manufactured by Nippon Zeon Co., Ltd.), is applied, as the fourth retardation plate RF4, to the surface of the liquid crystal polymer functioning as the third retardation plate RF3.

Similarly, the fifth retardation plate RF5 with a normal-directional phase difference of 100 nm is formed on the surface of the film that is used as the second retardation plate RF2. Subsequently, a retardation plate functioning as the sixth retardation plate RF6 with an in-plane phase difference of 50 nm is disposed on the surface of the fifth retardation plate RF5.

On the other hand, the back surface (opposed to the liquid crystal cell C) of the film that is used as the second retardation plate RF2 is rubbed, and the rubbed surface is coated with an ultraviolet cross-linking chiral nematic liquid crystal (manufactured by Merck Ltd.) with a thickness of 2.36 μm, which has a refractive index anisotropy Δn of 0.102 and a helical pitch of 0.9 μm. The coated liquid crystal layer is irradiated with ultraviolet in the state in which the helical axis agrees with the normal direction of the film. This liquid crystal polymer layer functions as the seventh retardation plate RF7. The normal-directional phase difference of the seventh retardation plate RF7, which is thus obtained, is −220 nm.

The first retardation plate RF1 having the third retardation plate RF3 and fourth retardation plate RF4 is attached via an adhesive layer, such as glue, such that the first retardation plate RF1 is opposed to the liquid crystal layer 7. In addition, a polarizer plate of SRW062A (manufactured by Sumitomo Chemical Co., Ltd.) is attached as the first polarizer plate PL1 via an adhesive layer, such as glue, on the fourth retardation plate RF4. The first polarizer plate PL1 is disposed such that the absorption axis thereof intersects at right angles with the slow axis of the fourth retardation plate RF4.

On the other hand, the second retardation plate RF2 having the fifth retardation plate RF5, sixth retardation plate RF6 and seventh retardation plate RF7 is attached via an adhesive layer, such as glue, such that the seventh retardation plate RF7 is opposed to the liquid crystal layer 7. In addition, a polarizer plate of SRW062A (manufactured by Sumitomo Chemical Co., Ltd.) is attached as the second polarizer plate PL2 via an adhesive layer, such as glue, on the sixth retardation plate RF6. The second polarizer plate PL2 is disposed such that the absorption axis thereof intersects at right angles with the slow axis of the sixth retardation plate RF6.

The angle between the transmission axis of each of the first polarizer plate PL1 and second polarizer plate PL2 and the slow axis of each of the first retardation plate RF1 and second retardation plate RF2 is π/4 (rad). Protrusions 12 and slits 11 are arranged such that the orientation direction of liquid crystal molecules at the time when voltage is applied to the liquid crystal layer 7 is parallel or perpendicular to the transmission axes of the first polarizer plate PL1 and second polarizer plate PL2. The absorption axis of the second polarizer plate PL2 and the absorption axis of the first polarizer plate PL1 are disposed to intersect at right angles with each other. Further, the slow axis of the first retardation plate RF1 and the slow axis of the second retardation plate RF2 are disposed to intersect at right angles with each other.

In the liquid crystal display device with this structure, a voltage of 4.2 V (at white display time) and a voltage of 1.0 V (at black display time; this voltage is lower than a threshold voltage of liquid crystal material, and with this voltage the liquid crystal molecules remain in the vertical alignment) were applied to the liquid crystal layer 7, and the viewing angle characteristics of the contrast ratio were evaluated.

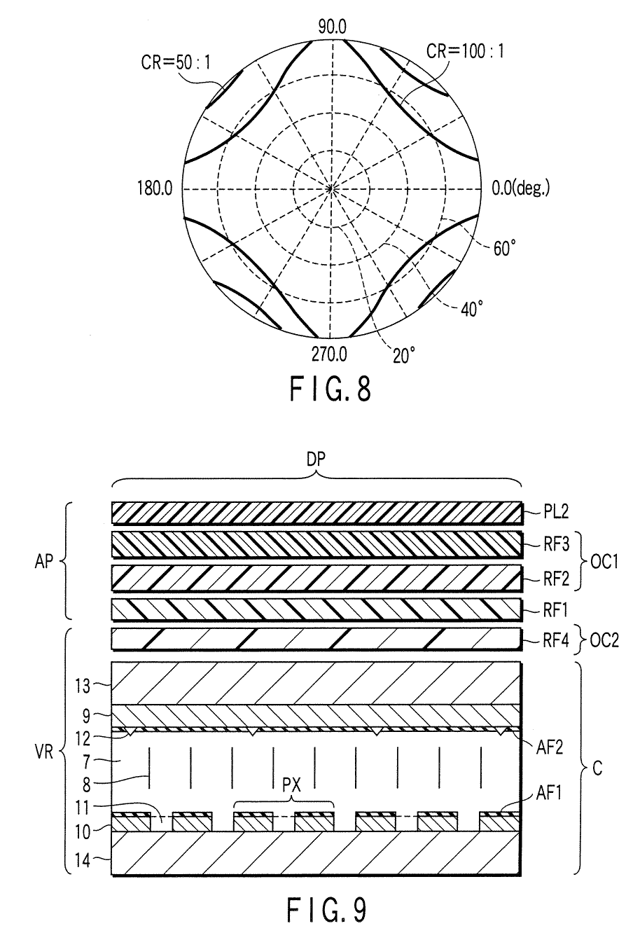

FIG. 8 shows the measurement result. It was confirmed that in almost all azimuth directions, the viewing angle with a contrast ratio of 50:1 or more was ±80° or more, and excellent viewing angle characteristics were obtained. In addition, the transmittance at 4.2 V was measured, and it was confirmed that a very high transmittance of 5.0% was obtained.

### Fourth Embodiment

The above-described first to third embodiments are directed to liquid crystal display devices in which a transmissive part is provided in at least a part of the pixel PX of the liquid crystal cell C or in at least a part of the display region DP. The invention, however, is not limited to these embodiments. The same structure as in the present invention is also applicable to, e.g. a transflective liquid crystal display device wherein a reflective layer is provided on at least a part of the pixel PX of the liquid crystal cell C, a partial-reflective liquid crystal display device wherein a reflective layer is provided in at least a part of the display region DP, and a reflective liquid crystal display device wherein a reflective layer is provided on the entire region of all pixels PX.

Specifically, as shown in FIG. 9, a circular-polarization-based MVA-mode liquid crystal display device comprises a circular polarizer/analyzer structure AP and a variable retarder structure VR, which are stacked in the named order. The variable retarder structure VR includes a dot-matrix liquid crystal cell C in which a liquid crystal layer is held between two electrode-equipped substrates. Specifically, this liquid crystal cell C is an MVA mode liquid crystal cell, and a liquid crystal layer 7 is sandwiched between an active matrix substrate 14 and a counter-substrate 13. In the liquid crystal cell C, a display region DP is composed of pixels PX that are arranged in a matrix.

The example shown in FIG. 9 is a reflective liquid crystal display device. A pixel electrode 10, which is disposed in each pixel PX, functions as a reflective layer and is formed of a light-reflective metal material such as aluminum. In the reflective part including the reflective layer, the thickness d of the liquid crystal layer 7 is set at about half the thickness of the transmissive part of the liquid crystal display device according to the above-described embodiments. In the other respects, the liquid crystal cell C has the same structure as shown in FIG. 1A, so a description is omitted here.

The circular polarizer/analyzer structure AP includes a polarizer plate PL and a uniaxial first retardation plate RF1 that is interposed between the polarizer plate PL and liquid crystal cell C. The first retardation plate RF1 is a uniaxial ¼ wavelength plate that has a fast axis and a slow axis in its plane, which are substantially perpendicular to each other, and provides a phase difference of ¼ wavelength between light rays with a predetermined wavelength (e.g. 550 nm), which pass through the fast axis and slow axis. The first retardation plate RF1 is disposed such that its slow axis forms an angle of about 45° with respect to the absorption axis of the polarizer plate PL. A retardation plate that is applicable to the first retardation plate RF1 should have a refractive index anisotropy (nx>ny=nz) as shown in FIG. 2.

The liquid crystal display device with this structure includes a first optical compensation layer OC1, which is disposed for optical compensation of the circular polarizer/analyzer structure AP (including the base film of the polarizer plate PL) between the polarizer plate PL and first retardation plate RF1; and a second optical compensation layer OC2, which is disposed for optical compensation of the variable retarder structure VR between the first retardation plate RF1 and the liquid crystal cell C.

Specifically, the first optical compensation layer OC1 compensates the viewing angle characteristics of the circular polarizer/analyzer structure AP so that emission light from the circular polarizer/analyzer structure AP may become substantially circularly polarized light, regardless of the direction of emission. The first optical compensation layer OC1 includes an optically uniaxial second retardation plate (positive C-plate) RF2 which has a refractive index anisotropy of nx≅ny<nz, and an optically uniaxial third retardation plate (positive A-plate) RF3 which has a refractive index anisotropy of nx>ny≅nz. The third retardation plate RF3 is disposed such that its slow axis is substantially perpendicular to the absorption axis of the polarizer plate PL.

The second optical compensation layer OC2 compensates the viewing angle characteristics of the phase difference of the liquid crystal cell C in the variable retarder structure VR (i.e. an optically positive normal-directional phase difference of the liquid crystal layer 7 in the state in which the liquid crystal molecules 8 are aligned substantially vertical to the major surface of the substrate, that is, in the state of black display). The second optical compensation layer OC2 includes an optically uniaxial fourth retardation plate (negative C-plate) RF4 which has a refractive index anisotropy of nx≅ny>nz.

The first retardation plate RF1 in this example can be formed of the same material as the second retardation plate which has been described with reference to FIG. 1A. The second retardation plate RF2 in this example can be formed of the same material as the fifth retardation plate which has been described with reference to FIG. 1A. The third retardation plate RF3 in this example can be formed of the same material as the sixth retardation plate which has been described with reference to FIG. 1A. The fourth retardation plate RF4 in this example can be formed of the same material as the seventh retardation plate described with reference to FIG. 1A.

As described in connection with the prior art, in the liquid crystal display device with the reflective part, too, the viewing-angle characteristics can be improved by using biaxial retardation plates. According to the structure of this embodiment, however, the uniaxial first retardation plate (¼ wavelength plate) RF1 and the first optical compensation layer OC1 are combined. Hence, it becomes possible to provide substantially the same function as the biaxial retardation plate that is capable of improving viewing angle characteristics. Thereby, the viewing angle characteristics can be improved, and the cost can be reduced, compared to the case of using the biaxial retardation plate.

Needless to say, a single liquid crystal cell C may be configured to include both the above-described transmissive part and reflective part.

As has been described in connection with each of the embodiments, the first optical compensation layer OC1 may be composed of the above-described single optical film 200. In addition, the first retardation plate RF1 and second retardation plate RF2 may be composed of the above-described single optical film 200. Further, the first retardation plate RF1 and fourth retardation plate RF4 may be composed of the above-described single biaxial retardation plate BR2. Even in the case of using these components, the same function as the liquid crystal display device having the structure shown in FIG. 9 can be realized.

### Fifth Embodiment

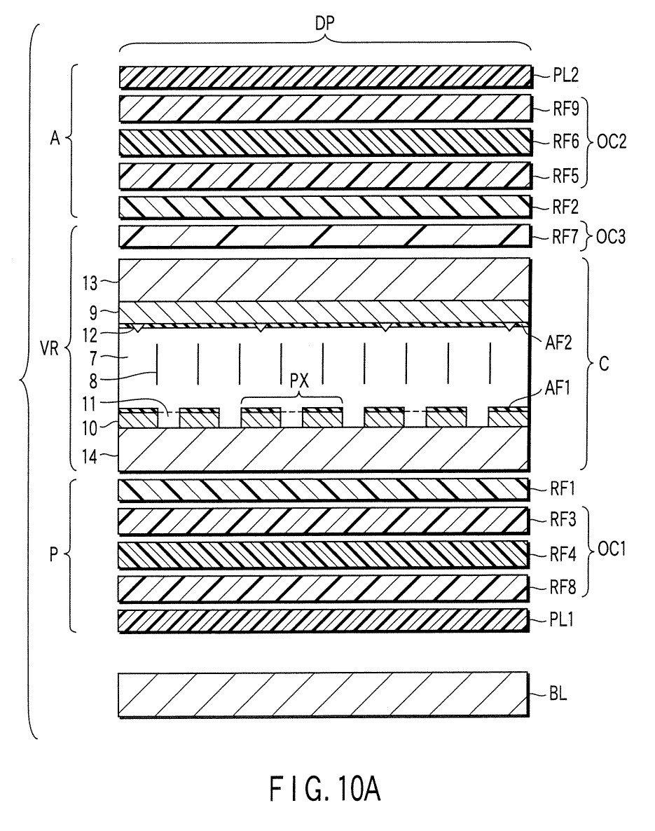

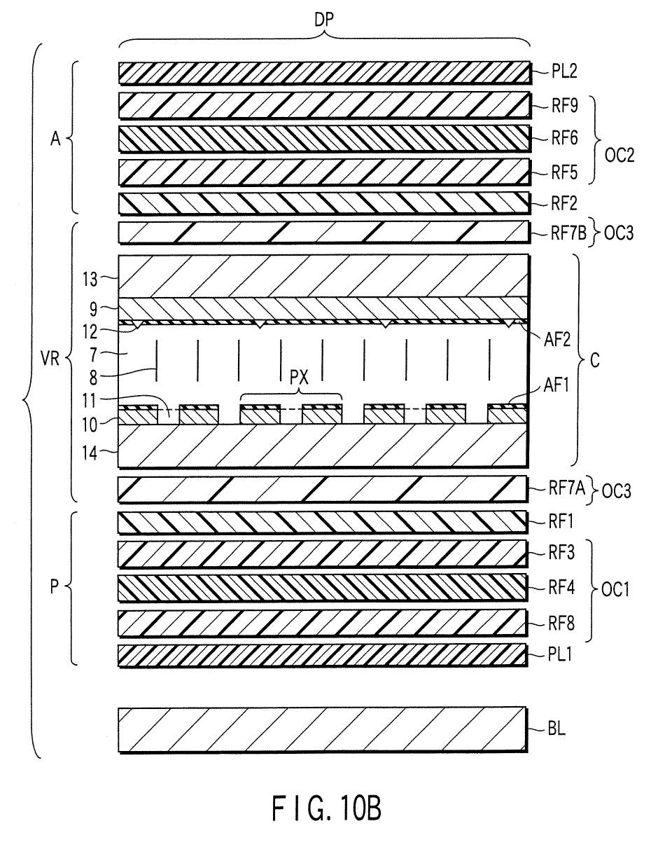

In a fifth embodiment of the invention, retardation plates are added to the structure of the first embodiment described in connection with FIG. 1A. Specifically, as shown in FIG. 10A, the first optical compensation layer OC1 includes, in addition to the third retardation plate (positive C-plate) RF3 and fourth retardation plate (positive A-plate) RF4, an optically uniaxial eighth retardation plate (positive C-plate) RF8 having a refractive index anisotropy of nx≅ny<nz. The second optical compensation layer OC2 includes, in addition to the fifth retardation plate (positive C-plate) RF5 and sixth retardation plate (positive A-plate) RF6, an optically uniaxial ninth retardation plate (positive C-plate) RF9 having a refractive index anisotropy of nx≅ny<nz. In the other respects, the structure of the fifth embodiment is the same as that of the first embodiment.

A retardation plate that is applicable to the first retardation plate RF1, second retardation plate RF2, fourth retardation plate RF4 and sixth retardation plate RF6 should have a refractive index anisotropy (nx>ny≅nz) as shown in FIG. 2. Each of the fourth retardation plate RF4 and sixth retardation plate RF6 has an in-plane phase difference of, e.g. 130 nm. A retardation plate that is applicable to the third retardation plate RF3, fifth retardation plate RF5, eighth retardation plate RF8 and ninth retardation plate RF9 should have a refractive index anisotropy (nx≅ny<nz) as shown in FIG. 3. Each of the third retardation plate RF3 and fifth retardation plate RF5 has a normal-directional phase difference of, e.g. 130 nm. Each of the eighth retardation plate RF8 and ninth retardation plate RF9 has a normal-directional phase difference of, e.g. 70 nm. A retardation plate that is applicable to the seventh retardation plate RF7 should have a refractive index anisotropy (nx≅ny>nz) as shown in FIG. 4. The seventh retardation plate RF7 has a normal-directional phase difference of, e.g. −220 nm.

The eighth retardation plate RF8 and ninth retardation plate RF9, like the third retardation plate RF3 and sixth retardation plate RF6, should preferably be formed of a nematic liquid crystal polymer having a normal-directional optical axis. It is difficult to form a film with a positive phase difference in the normal direction by a conventional drawing technique. Thus, the formation is made easier by using a nematic liquid crystal polymer or a discotic liquid crystal polymer, which has a normal-directional optical axis.

With this fifth embodiment, too, the same advantageous effect as with the first embodiment can be obtained.

### Modification of the Fifth Embodiment

In a modification of the fifth embodiment, the liquid crystal display device may include a third optical compensation layer OC3 which is divided into two segments with separated functions. Specifically, as shown in FIG. 10B, the seventh retardation plate RF7, which constitutes the third optical compensation layer OC3, is functionally divided into a first segment layer RF7A, which is disposed between the first retardation plate RF1 and the liquid crystal cell C, and a second segment layer RF7B, which is disposed between the second retardation plate RF2 and the liquid crystal cell C. In this structure, the total thickness of the first segment layer RF7A and second segment layer RF7B is set to be, for instance, T, which is the thickness of the functional layer that functions as the seventh retardation plate RF7. Thereby, the same function as with the liquid crystal display device shown in FIG. 10A is realized.

### Sixth Embodiment

In a liquid crystal display device according to a sixth embodiment of the invention, at least one of the first optical compensation layer OC1 and second optical compensation layer OC2 is composed of a single optical film in which two liquid crystal films are stacked. In each of the two liquid crystal films, liquid crystal polymer molecules, which exhibit positive uniaxiality in the major plane of the film, are nematic-hybrid-aligned along the normal direction.

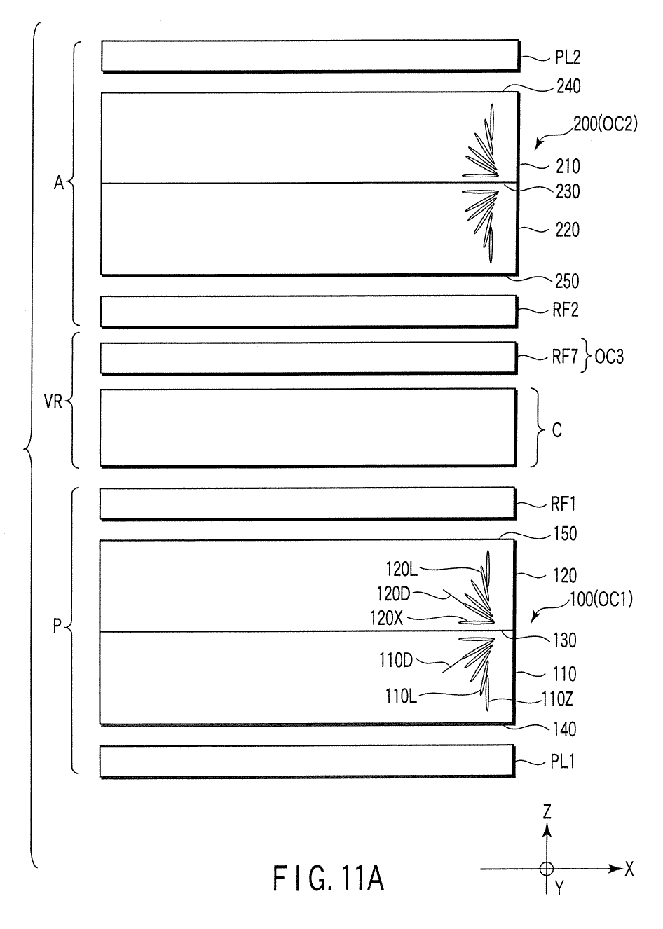

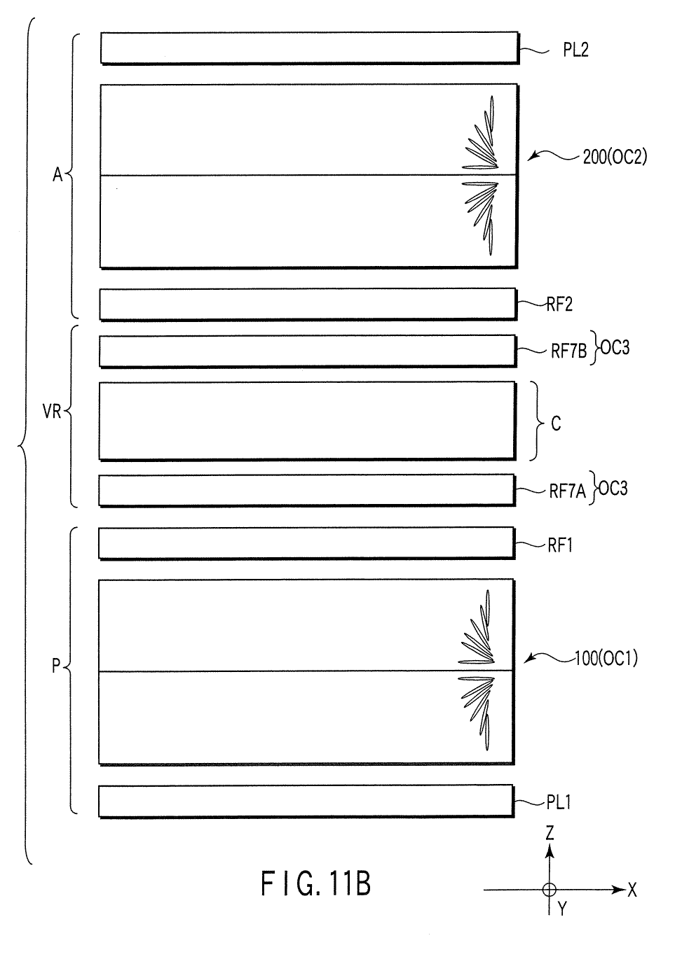

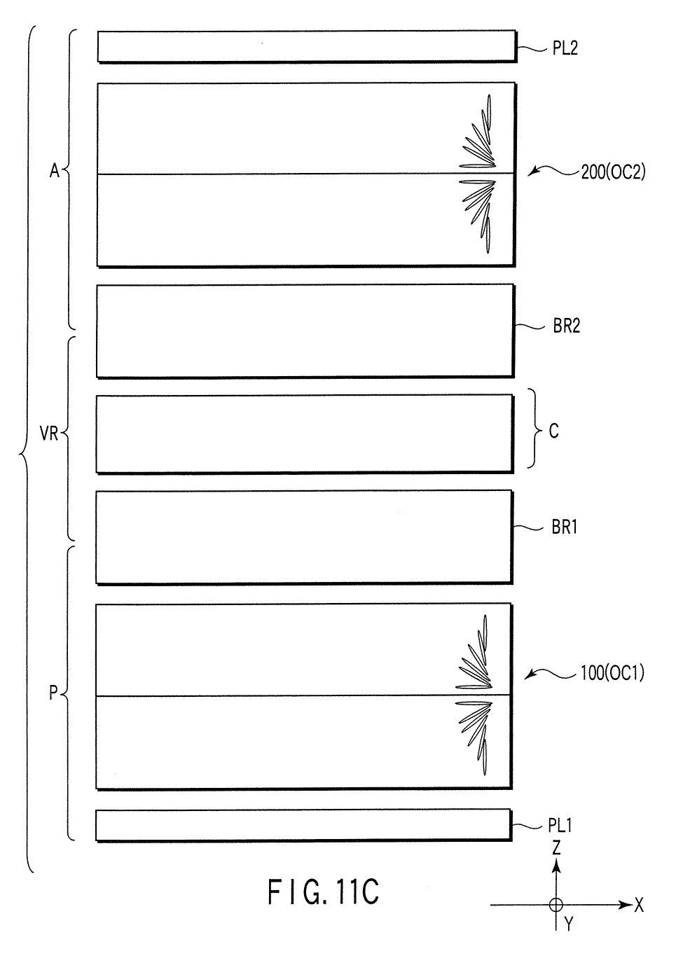

FIG. 11A schematically shows the structure of the liquid crystal display device according to the sixth embodiment of the invention. As shown in FIG. 11A, the liquid crystal display device is a crystal display device of a circular-polarization-based vertical alignment mode in which liquid crystal molecules in each pixel are aligned substantially vertical to the major surface of the substrate in a voltage-off state. The liquid crystal display device comprises a circular polarizer structure P, a variable retarder structure VR and a circular analyzer structure A. The structural elements common to those in the fifth embodiment are denoted by like reference numerals, and a detailed description is omitted.

The first optical compensation layer OC1 is composed of a single optical film 100. The optical film 100 has an optical function equivalent to the total refractive index anisotropy of the third retardation plate, fourth retardation plate and eighth retardation plate which are described in the fifth embodiment. In short, in the sixth embodiment the third retardation plate RF3, fourth retardation plate RF4 and eighth retardation plate RF8 in the fifth embodiment are replaced with the single optical film 100.

Similarly, the second optical compensation layer OC2 is composed of a single optical film 200. The optical film 200 has an optical function equivalent to the total refractive index anisotropy of the fifth retardation plate, sixth retardation plate and ninth retardation plate which are described in the fifth embodiment. In short, in the sixth embodiment the fifth retardation plate RF5, sixth retardation plate RF6 and ninth retardation plate RF9 in the fifth embodiment are replaced with the single optical film 200.

Since the optical films 100 and 200 have substantially the same structure, the structure of the optical film 100 is described here in detail. Specifically, as shown in FIG. 11A, the optical film 100 comprises a first liquid crystal film 110 and a second liquid crystal film 120 which is stacked on the first liquid crystal film 110. The first liquid crystal film 110 is disposed on the outer side (i.e. the first polarizer plate PL1 side of the optical film 100). The second liquid crystal film 120 is disposed on the inner side (i.e. the first retardation plate RF1 side of the optical film 100).

Each of the first liquid crystal film 110 and second liquid crystal film 120 includes liquid crystal polymer molecules which exhibit positive uniaxiality in the major plane of the film. The liquid crystal polymer molecules included in the first liquid crystal film 110 and second liquid crystal film 120 are fixed in the state in which the liquid crystal polymer molecules are nematic-hybrid-aligned along the normal direction in the liquid crystal state.

In the optical film 100, directors 110D and 120D of the liquid crystal polymer molecules 110L and 120L in the first liquid crystal film 110 and second liquid crystal film 120 are parallel in the major plane and perpendicular to each other in a cross-sectional plane extending in the normal direction. In addition, the directors 110D and 120D of the liquid crystal polymer molecules 110L and 120L in the first liquid crystal film 110 and second liquid crystal film 120 are symmetric with respect to a bonding interface 130 between the first liquid crystal film 110 and second liquid crystal film 120.

Specifically, in the major plane defined by the X axis and Y axis, the liquid crystal polymer molecules 110L included in the first liquid crystal film 110 are not twisted and the director 110D of the liquid crystal polymer molecules 110L is oriented in one direction when the liquid crystal polymer molecules 110L are orthogonally projected. When it is assumed that the director 110D of the liquid crystal polymer molecules 110L is substantially parallel to the X axis, the liquid crystal polymer molecules 110L are, in the cross section defined by the X axis and Z axis, substantially parallel to the bonding interface 130 in the vicinity of the bonding interface 130 and are substantially perpendicular to the bonding interface 130 in the vicinity of an outer surface 140 of the first liquid crystal film 110. In other words, in the first liquid crystal film 110, the liquid crystal polymer molecules 110L are distributed along the normal direction Z such that the angle (tilt angle) between their director 110D and the bonding interface 130 falls within the range between 0° and 90°.

Similarly, in the major plane defined by the X axis and Y axis, the liquid crystal polymer molecules 120L included in the second liquid crystal film 120 are not twisted and the director 120D of the liquid crystal polymer molecules 120L is oriented in one direction when the liquid crystal polymer molecules 120L are orthogonally projected. At this time, the second liquid crystal film 120 is disposed such that the director 120D of the liquid crystal polymer molecules 120L is substantially parallel to the X axis. In other words, the director 110D of the liquid crystal polymer molecules 110L and the director 120D of the liquid crystal polymer molecules 120L are parallel in the major plane.

In addition, in the cross section defined by the X axis and Z axis, the liquid crystal polymer molecules 120L are substantially parallel to the bonding interface 130 in the vicinity of the bonding interface 130 and are substantially perpendicular to the bonding interface 130 in the vicinity of an outer surface 150 of the second liquid crystal film 120. In other words, in the second liquid crystal film 120, too, the liquid crystal polymer molecules 120L are distributed along the normal direction Z such that the angle (tilt angle) between their director 120D and the bonding interface 130 falls within the range between 0° and 90°.

Thus, the second liquid crystal film 120 includes the liquid crystal polymer molecules 120L having the director 120D which intersects at right angles with the director 110D of the liquid crystal polymer molecules 110L included in the first liquid crystal film 110 in the cross section defined by the X axis and Z axis. In FIG. 11A, for example, the tilt angle of a liquid crystal polymer molecule 110Z included in the first liquid crystal film 110 is about 90° while the tilt angle of a liquid crystal polymer molecule 120X included in the second liquid crystal film 120 is about 0°, and the directors of these liquid crystal polymer molecule 110Z and liquid crystal polymer molecule 120X are perpendicular to each other. The same relationship applies to the other liquid crystal polymer molecules 110L and 120L included in the first liquid crystal film 110 and second liquid crystal film 120.

When the refractive index in the direction of the director 110D, 120D (i.e. direction parallel to the X axis) of the liquid crystal polymer molecule 110L, 120L is nx, the refractive index in the direction perpendicular to the direction of the director 11D, 120D (i.e. direction parallel to the Y axis) is ny and the refractive index in the normal direction (i.e. direction parallel to the Z axis) is nz, the optical film 100 has a refractive index anisotropy of nx>ny=nz in the vicinity of the bonding interface 130 and has a refractive index anisotropy of nx=ny<nz in the vicinity of the outer surfaces 140 and 150 of the first liquid crystal film 110 and second liquid crystal film 120.

Specifically, the first liquid crystal film 110 exhibits a refractive index anisotropy that is equivalent to a positive A-plate (nx>ny=nz) in the vicinity of the bonding interface 130, and an in-plane phase difference is set at about 65 nm. Further, the first liquid crystal film 110 exhibits a refractive index anisotropy that is equivalent to a positive C-plate (nx=ny<nz) in the vicinity of the outer surface 140, and a normal-directional phase difference is set at about 130 nm.

Similarly, the second liquid crystal film 120 exhibits a refractive index anisotropy that is equivalent to a positive A-plate (nx>ny=nz) in the vicinity of the bonding interface 130, and an in-plane phase difference is set at about 65 nm. Further, the second liquid crystal film 120 exhibits a refractive index anisotropy that is equivalent to a positive C-plate (nx=ny<nz) in the vicinity of the outer surface 150, and a normal-directional phase difference is set at about 70 nm.

Specifically, in the optical film 100, the mean value of the normal-directional phase difference of the second liquid crystal film 120, which is located on the first retardation plate RF1 side, is substantially equal to the normal-directional phase difference of the third retardation plate RF3, and a total normal-directional phase difference of about 130 nm is provided. In addition, the sum of mean values of the in-plane phase differences of the first liquid crystal film 110 and second liquid crystal film 120 is substantially equal to the in-plane phase difference of the fourth retardation plate RF4, and a total in-plane phase difference of about 130 nm is provided. Further, the mean value of the normal-directional phase difference of the first liquid crystal film 110, which is located on the first polarizer plate PL1 side, is substantially equal to the normal-directional phase difference of the eighth retardation plate RF8, and a total normal-directional phase difference of about 70 nm is provided.

The optical film 200 is similarly structured. Specifically, a first liquid crystal film 210 of the optical film 200, which is disposed on the second polarizer plate PL2 side, exhibits a refractive index anisotropy that is equivalent to a positive A-plate (nx>ny=nz) in the vicinity of a bonding interface 230, and an in-plane phase difference is set at about 65 nm. Further, the first liquid crystal film 210 exhibits a refractive index anisotropy that is equivalent to a positive C-plate (nx=ny<nz) in the vicinity of an outer surface 240, and a normal-directional phase difference is set at about 130 nm.

Similarly, a second liquid crystal film 220 of the optical film 200, which is disposed on the second retardation plate RF2 side, exhibits a refractive index anisotropy that is equivalent to a positive A-plate (nx>ny=nz) in the vicinity of the bonding interface 230, and an in-plane phase difference is set at about 65 nm. Further, the second liquid crystal film 220 exhibits a refractive index anisotropy that is equivalent to a positive C-plate (nx=ny<nz) in the vicinity of an outer surface 250, and a normal-directional phase difference is set at about 70 nm.

Specifically, in the optical film 200, the mean value of the normal-directional phase difference of the second liquid crystal film 220, which is located on the second retardation plate RF2 side, is substantially equal to the normal-directional phase difference of the fifth retardation plate RF5, and a total normal-directional phase difference of about 130 nm is provided. In addition, the sum of mean values of the in-plane phase differences of the first liquid crystal film 210 and second liquid crystal film 220 is substantially equal to the in-plane phase difference of the sixth retardation plate RF6, and a total in-plane phase difference of about 130 nm is provided. Further, the mean value of the normal-directional phase difference of the first liquid crystal film 210, which is located on the second polarizer plate PL2 side, is substantially equal to the normal-directional phase difference of the ninth retardation plate RF9, and a total normal-directional phase difference of about 70 nm is provided.

In the above-described sixth embodiment, in the optical film 100 functioning as the first optical compensation layer OC1, the director of the liquid crystal molecule that is aligned substantially horizontal to the film surface is so disposed as to intersect at right angles with the absorption axis of the first polarizer plate PL1. In addition, in the optical film 200 functioning as the second optical compensation layer OC2, the director of the liquid crystal molecule that is aligned substantially horizontal to the film surface is so disposed as to intersect at right angles with the absorption axis of the second polarizer plate PL2.

The optical films 100 and 200 that are applicable to the sixth embodiment can be formed by preparing a first liquid crystal film 110 and a second liquid crystal film 120 each having a hybrid-aligned liquid crystal layer on a base film and bonding the outer surfaces of the respective base films. In this optical film, a bonding interface is formed between the outer surfaces of the base films. In the sixth embodiment, it is possible to use, as the optical film, a liquid crystal film having hybrid-aligned liquid crystal layers on both sides of a single base film. In this case, the surface of the base film may be regarded as a substantial bonding interface.

According to the sixth embodiment with the above-described structure, the same function as with the fifth embodiment can be obtained and, moreover, the functions of a plurality of retardation plates can be realized by a single optical film. Thereby, the number of components can be reduced, the layer thickness of the device can be deceased, and the reduction in thickness of the device can advantageously be achieved. The above-described single optical film which has the functions of plural retardation plates can easily be formed even under a condition which is difficult to meet in the case of a biaxial drawn film. Moreover, the cost can be reduced.

### Modification 1 of the Sixth Embodiment

In Modification 1 of the sixth embodiment, the liquid crystal display device may include a third optical compensation layer OC3 which is divided into two segments with separated functions. Specifically, as shown in FIG. 11B, the seventh retardation plate RF7, which constitutes the third optical compensation layer OC3, is functionally divided, like the modification shown in FIG. 10B, into a first segment layer RF7A, which is disposed between the first retardation plate RF1 and the liquid crystal cell C, and a second segment layer RF7B, which is disposed between the second retardation plate RF2 and the liquid crystal cell C. With this structure, too, the same function as with the liquid crystal display device shown in FIG. 11A is realized.

### Modification 2 of the Sixth Embodiment

In Modification 2 of the sixth embodiment, which is a further modification of Modification 1 shown in FIG. 11B, the first segment layer RF7A and first retardation plate RF1 may be formed of a single biaxial retardation plate BR1, as shown in FIG. 11C. The single biaxial retardation plate BR1 has such a total optical function as to impart a phase difference of ¼ wavelength between light rays of a predetermined wavelength that pass through its fast axis and slow axis, and to be equivalent to a biaxial refractive index anisotropy of nx>ny>nz. The retardation plate BR1 is disposed between the liquid crystal cell C and optical film 100.

Similarly, the second segment layer RF7B and second retardation plate RF2 may be formed of a single biaxial retardation plate BR2. The single biaxial retardation plate BR2 has such a total optical function as to impart a phase difference of ¼ wavelength between light rays of a predetermined wavelength that pass through its fast axis and slow axis, and to be equivalent to a biaxial refractive index anisotropy of nx>ny>nz. The retardation plate BR2 is disposed between the liquid crystal cell C and optical film 200.

In order to realize the same function as the first retardation plate RF1 and second retardation plate RF2, each of the retardation plates BR1 and BR2 has a function of a ¼ wavelength plate which imparts a ¼ wavelength phase difference (i.e. in-plane phase difference of 140 nm) between light rays of a predetermined wavelength (e.g. 550 nm) that pass through its fast axis and slow axis in the major plane. In addition, in order to realize the same function as the first segment layer RF7A and second segment layer RF7B, each of the retardation plates BR1 and BR2 has a function of a retardation plate having a negative normal-directional phase difference (e.g. −110 nm) in the normal direction.

With this structure, too, the same function as that of the liquid crystal display device shown in FIG. 11A can be realized. Since the functions of a plurality of retardation plates can be realized by a single optical film, the number of components can be reduced, the layer thickness of the device can be deceased, and the reduction in thickness of the device can advantageously be achieved.

In the above-described sixth embodiment, in each of the structures shown in FIG. 11A to FIG. 11C, the first optical compensation layer OC1 is composed of the optical film 100 and the second optical compensation layer OC2 is composed of the optical film 200. Alternatively, only one of the first and second optical compensation layers OC1 and OC2 may be formed of the optical film, and the same function can be realized.

Similarly, in the structure shown in FIG. 11C, the first retardation plate RF1 and first segment RF7A are composed of the single biaxial retardation plate BR1, and the second retardation plate RF2 and second segment RF7B are composed of the single biaxial retardation plate BR2. Alternatively, only the first retardation plate RF1 and first segment RF7A, or the second retardation plate RF2 and second segment RF7B may be composed of the single biaxial retardation plate, and the same function can be realized.

### Seventh Embodiment

In a seventh embodiment of the invention, at least one of the combination of the first retardation plate RF1 and third retardation plate RF3, the combination of the fourth retardation plate RF4 and eighth retardation plate RF8, the combination of the second retardation plate RF2 and fifth retardation plate RF5 and the combination of the sixth retardation plate RF6 and ninth retardation plate RF9 in the fifth embodiment is composed of a single optical film in which two liquid crystal films are stacked. In each of the two liquid crystal films, liquid crystal polymer molecules, which exhibit positive uniaxiality in the major plane of the film, are nematic-hybrid-aligned along the normal direction. In the other respects, the structure of the seventh embodiment is the same as that of the fifth embodiment. The common structural elements are denoted by like reference numerals and a detailed description is omitted.

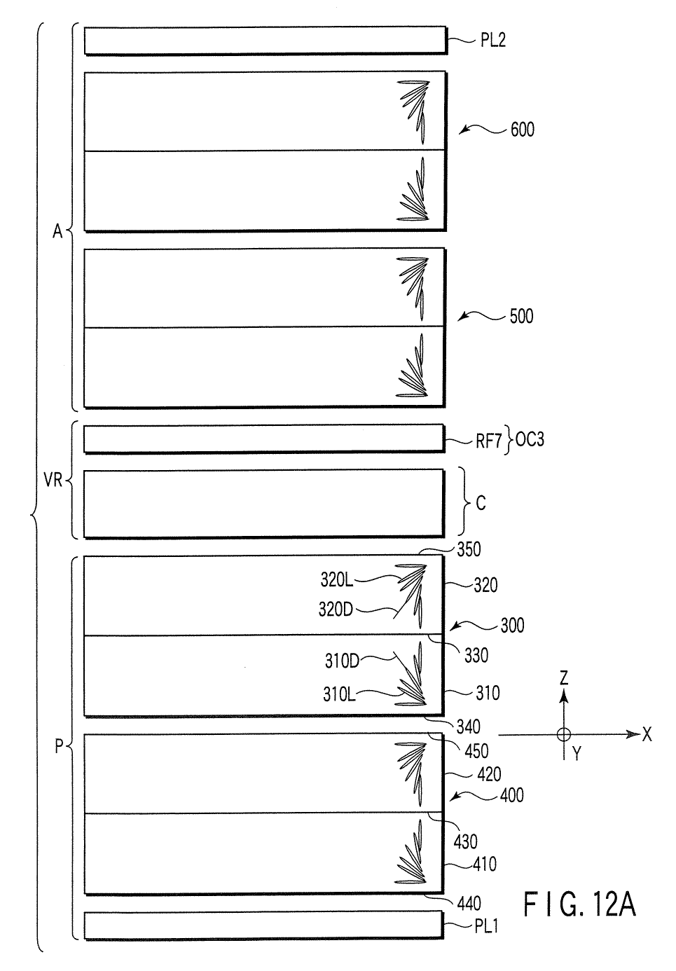

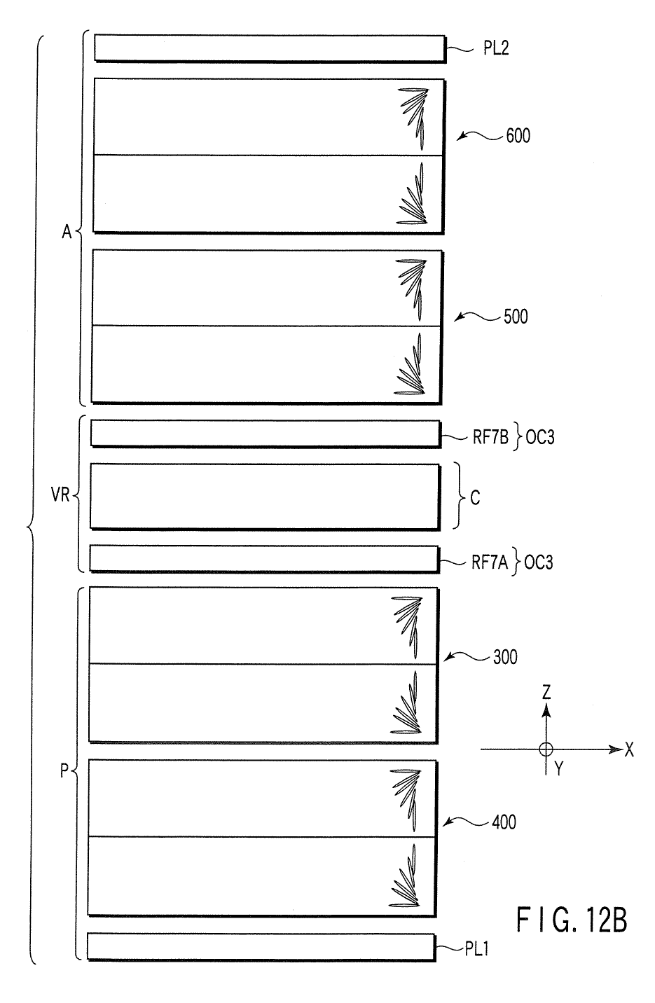

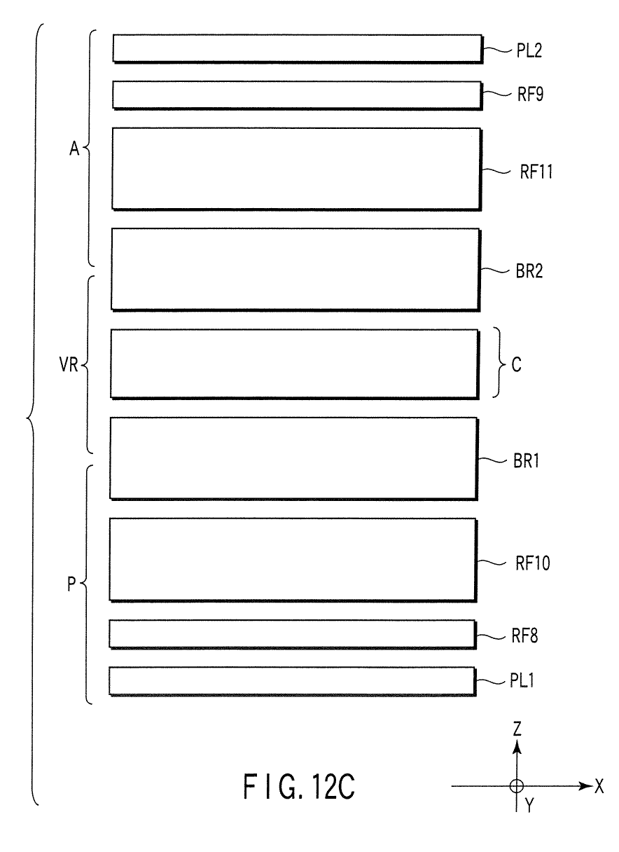

As is shown in FIG. 12A, the circular polarizer structure P includes a first polarizer plate PL1, a single optical film 300 which is disposed between the first polarizer plate PL1 and a liquid crystal cell C, and a single optical film 400 which is disposed between the first polarizer plate PL1 and the optical film 300. The optical film 300 has an optical function that is equivalent to a total refractive index anisotropy of the first retardation plate and third retardation plate described in the fifth embodiment. In short, in the seventh embodiment the first retardation plate RF1 and third retardation plate RF3 in the fifth embodiment are replaced with the single optical film 300. The optical film 400 has an optical function that is equivalent to a total refractive index anisotropy of the fourth retardation plate and eighth retardation plate described in the fifth embodiment. In short, in the seventh embodiment the fourth retardation plate RF4 and eighth retardation plate RF8 in the fifth embodiment are replaced with the single optical film 400.

Similarly, the circular analyzer structure A includes a second polarizer plate PL2, a single optical film 500 which is disposed between the second polarizer plate PL2 and the liquid crystal cell C, and a single optical film 600 which is disposed between the second polarizer plate PL2 and the optical film 500. The optical film 500 has an optical function that is equivalent to a total refractive index anisotropy of the second retardation plate and fifth retardation plate described in the fifth embodiment. In short, in the seventh embodiment the second retardation plate RF2 and fifth retardation plate RF5 in the fifth embodiment are replaced with the single optical film 500. The optical film 600 has an optical function that is equivalent to a total refractive index anisotropy of the sixth retardation plate and ninth retardation plate described in the fifth embodiment. In short, in the seventh embodiment the sixth retardation plate RF6 and ninth retardation plate RF9 in the fifth embodiment are replaced with the single optical film 600.

The detailed structures of the optical films 300 to 600 are the same as those of the optical films 100 and 200 which have been described in connection with the second embodiment.

When the refractive index in the direction of director 310D, 320D (i.e. direction parallel to the X axis) of a liquid crystal polymer molecule 310L, 320L is nx, the refractive index in the direction perpendicular to the direction of the director 310D, 320D (i.e. direction parallel to the Y axis) is ny and the refractive index in the normal direction (i.e. direction parallel to the Z axis) is nz, the optical film 300 has a refractive index anisotropy of nx>ny=nz in the vicinity of a bonding interface 330 and has a refractive index anisotropy of nx=ny<nz in the vicinity of the outer surfaces 340 and 350 of a first liquid crystal film 310 and a second liquid crystal film 320.

Specifically, the first liquid crystal film 310 exhibits a refractive index anisotropy that is equivalent to a positive C-plate (nx=ny<nz) in the vicinity of the bonding interface 330, and a normal-directional phase difference is set at about 65 nm. Further, the first liquid crystal film 310 exhibits a refractive index anisotropy that is equivalent to a positive A-plate (nx>ny=nz) in the vicinity of the outer surface 340, and an in-plane phase difference is set at about 70 nm.

Similarly, the second liquid crystal film 320 exhibits a refractive index anisotropy that is equivalent to a positive C-plate (nx=ny<nz) in the vicinity of the bonding interface 330, and a normal-directional phase difference is set at about 65 nm. Further, the second liquid crystal film 320 exhibits a refractive index anisotropy that is equivalent to a positive A-plate (nx>ny=nz) in the vicinity of the outer surface 350, and an in-plane phase difference is set at about 70 nm.

Specifically, the optical film 300 has a normal-directional phase difference of about 130 nm in total, and has an in-plane phase difference of about 140 nm in total. The optical film 500 is similarly structured. In short, in order to realize the same function as the third retardation plate RF3 and fifth retardation plate RF5, each of the optical films 300 and 500 has a function of a retardation plate having a positive normal-directional phase difference (e.g. 130 nm) in the normal direction. In addition, in order to realize the same function as the first retardation plate RF1 and second retardation plate RF2, each of the optical films 300 and 500 has a function of a ¼ wavelength plate which imparts a ¼ wavelength in-plane phase difference (140 nm) between light rays of a predetermined wavelength (e.g. 550 nm) that pass through its fast axis and slow axis in the major plane.

Besides, a first liquid crystal film 410, which is a structural component of the optical film 400, exhibits a refractive index anisotropy that is equivalent to a positive C-plate (nx=ny<nz) in the vicinity of a bonding interface 430, and a normal-directional phase difference is set at about 35 nm. Further, the first liquid crystal film 410 exhibits a refractive index anisotropy that is equivalent to a positive A-plate (nx>ny=nz) in the vicinity of an outer surface 440, and an in-plane phase difference is set at about 65 nm.

Similarly, a second liquid crystal film 420, which is a structural component of the optical film 400, exhibits a refractive index anisotropy that is equivalent to a positive C-plate (nx=ny<nz) in the vicinity of the bonding interface 430, and a normal-directional phase difference is set at about 35 nm. Further, the second liquid crystal film 420 exhibits a refractive index anisotropy that is equivalent to a positive A-plate (nx>ny=nz) in the vicinity of a outer surface 450, and an in-plane phase difference is set at about 65 nm.

Specifically, the optical film 400 has a normal-directional phase difference of about 70 nm in total, and has an in-plane phase difference of about 130 nm in total. The optical film 600 is similarly structured. In short, in order to realize the same function as the eighth retardation plate RF8 and ninth retardation plate RF9, each of the optical films 400 and 600 has a function of a retardation plate having a positive normal-directional phase difference (e.g. 70 nm) in the normal direction. In addition, in order to realize the same function as the fourth retardation plate RF4 and sixth retardation plate RF6, each of the optical films 400 and 600 has a function of a retardation plate having a positive normal-directional phase difference (e.g. 130 nm) in the major plane.

In the above-described seventh embodiment, in the optical film 400, the director of the liquid crystal molecule that is aligned substantially horizontal to the film surface is so disposed as to intersect at right angles with the absorption axis of the first polarizer plate PL1. In addition, in the optical film 600, the director of the liquid crystal molecule that is aligned substantially horizontal to the film surface is so disposed as to intersect at right angles with the absorption axis of the second polarizer plate PL2.

In the optical film 300, the director of the liquid crystal molecule that is aligned substantially horizontal to the film surface is so disposed as to form an angle of about 45° with respect to the absorption axis of the first polarizer plate PL1. In the optical film 500, the director of the liquid crystal molecule that is aligned substantially horizontal to the film surface is so disposed as to form an angle of about 45° with respect to the absorption axis of the second polarizer plate PL2.

According to the seventh embodiment with the above-described structure, the same function as with the fifth embodiment can be obtained and, moreover, the functions of a plurality of retardation plates can be realized by a single optical film. Thereby, the number of components can be reduced, the layer thickness of the device can be deceased, and the reduction in thickness of the device can advantageously be achieved. The above-described single optical film which has the functions of plural retardation plates can easily be formed even under a condition which is difficult to meet in the case of a biaxial drawn film. Moreover, the manufacturing cost can be reduced.

### Modification 1 of the Seventh Embodiment

In Modification 1 of the seventh embodiment, the liquid crystal display device may include a third optical compensation layer OC3 which is divided into two segments with separated functions. Specifically, as shown in FIG. 12B, the seventh retardation plate RF7, which constitutes the third optical compensation layer OC3, is functionally divided, like the modification shown in FIG. 10B, into a first segment layer RF7A, which is disposed between the optical film 300 and the liquid crystal cell C, and a second segment layer RF7B, which is disposed between the optical film 500 and the liquid crystal cell C. With this structure, too, the same function as with the liquid crystal display device shown in FIG. 12A is realized.

### Modification 2 of the Seventh Embodiment

In Modification 2 of the seventh embodiment, the first segment layer RF7A and first retardation plate RF1 may be formed of a single biaxial retardation plate BR1, as shown in FIG. 12C. The single biaxial retardation plate BR1 has such a total optical function as to impart a phase difference of ¼ wavelength between light rays of a predetermined wavelength that pass through its fast axis and slow axis, and to be equivalent to a biaxial refractive index anisotropy of nx>ny>nz.

Similarly, the second segment layer RF7B and second retardation plate RF2 may be formed of a single biaxial retardation plate BR2. The single biaxial retardation plate BR2 has such a total optical function as to impart a phase difference of ¼ wavelength between light rays of a predetermined wavelength that pass through its fast axis and slow axis, and to be equivalent to a biaxial refractive index anisotropy of nx>ny>nz.

The normal-directional phase difference (e.g. 130 nm), which is required for the function of the third retardation plate RF3 and fifth retardation plate RF5, is substantially equal to the in-plane phase difference (e.g. 130 nm) which is required for the function of the fourth retardation plate RF4 and sixth retardation plate RF6. Thus, each of the third retardation plate RF3 and fourth retardation plate RF4 may be composed of an optically uniaxial retardation plate (negative C-plate) RF10 which has a refractive index anisotropy of nx≅ny>nz. Similarly, each of the fifth retardation plate RF5 and sixth retardation plate RF6 may be composed of an optically uniaxial retardation plate (negative C-plate) RF11 which has a refractive index anisotropy of nx≅ny>nz.

In order to realize the same function as the fourth retardation plate RF4 and sixth retardation plate RF6, each of the retardation plates RF10 and RF11 has a function of a retardation plate having a positive in-plane phase difference (e.g. 130 nm) in the major plane. In addition, in order to realize the same function as the third retardation plate RF3 and fifth retardation plate RF5, each of the retardation plates RF10 and RF11 has a function of a retardation plate having a positive normal-directional phase difference (e.g. 130 nm) in the normal direction.

The biaxial retardation plate BR1 is disposed between the liquid crystal cell C and the retardation plate RF10. The biaxial retardation plate BR2 is disposed between the liquid crystal cell C and the retardation plate RF11.

In order to realize the same function as the first retardation plate RF1 and second retardation plate RF2, each of the retardation plates BR1 and BR2 has a function of a ¼ wavelength plate which imparts a ¼ wavelength phase difference (i.e. in-plane phase difference of 140 nm) between light rays of a predetermined wavelength (e.g. 550 nm) that pass through its fast axis and slow axis in the major plane. In addition, in order to realize the same function as the first segment layer RF7A and second segment layer RF7B, each of the retardation plates BR1 and BR2 has a function of a retardation plate having a negative normal-directional phase difference (e.g. −110 nm) in the normal direction.

With this structure, too, the same function as that of the liquid crystal display device shown in FIG. 12A can be realized. Since the functions of a plurality of retardation plates can be realized by a single optical film, the number of components can be reduced, the layer thickness of the device can be deceased, and the reduction in thickness of the device can advantageously be achieved.

A specific example of the present invention will be described below. The principal structure of the example is the same as that of the fifth embodiment shown in FIG. 10A.

### EXAMPLE 2

In a liquid crystal display device according to Example 2, an F-based liquid crystal (manufactured by Merck Ltd.) was used as a nematic liquid crystal material with negative dielectric anisotropy for the liquid crystal layer 7. The refractive index anisotropy Δn of the liquid crystal material used in this case is 0.095 (wavelength for measurement=550 nm; in the description below, all refractive indices and phase differences of retardation plates are values measured at wavelength of 550 nm), and the thickness d of the liquid crystal layer 7 is 3.5 μm. Thus, the Δn·d of the liquid crystal layer 7 is 330 nm.

In Example 2, a uniaxial ¼ wavelength plate (in-plane phase difference=140 nm), which is formed of ZEONOR resin (manufactured by Nippon Zeon Co., Ltd.), is used as the first retardation plate RF1 and second retardation plate RF2. A vertical alignment film, which is formed of JALS214-R14 (manufactured by JSR), is provided on the surface (opposed to the polarizer plate) of the film that is used as the first retardation plate RF1. Subsequently, a nematic liquid crystal polymer (manufactured by Merck Ltd.) is coated. The refractive index anisotropy Δn of this liquid crystal polymer is 0.040, and the thickness d thereof is 3.25 μm. Thus, the normal-directional phase difference of the liquid crystal polymer is 130 nm. This liquid crystal polymer functions as the third retardation plate RF3. Further, a uniaxial retardation plate (in-plane phase difference=130 nm), which is formed of ZEONOR resin (manufactured by Nippon Zeon Co., Ltd.), is applied, as the fourth retardation plate RF4, to the surface of the liquid crystal polymer functioning as the third retardation plate RF3. Besides, a liquid crystal polymer with a normal-directional phase difference of 70 nm is coated, as the eighth retardation plate RF8, on the surface of the fourth retardation plate RF4.

Similarly, the fifth retardation plate RF5 with a normal-directional phase difference of 130 nm is formed on the surface of the film that is used as the second retardation plate RF2. Subsequently, a retardation plate functioning as the sixth retardation plate RF6 with an in-plane phase difference of 130 nm is disposed on the surface of the fifth retardation plate RF5. Further, a retardation plate functioning as the ninth retardation plate RF9 with a normal-directional phase difference of 70 nm is disposed on the surface of the sixth retardation plate RF6.

On the other hand, the back surface (opposed to the liquid crystal cell C) of the film that is used as the second retardation plate RF2 is rubbed, and the rubbed surface is coated with an ultraviolet cross-linking chiral nematic liquid crystal (manufactured by Merck Ltd.) with a thickness of 2.36 μm, which has a refractive index anisotropy Δn of 0.102 and a helical pitch of 0.9 μm. The coated liquid crystal layer is irradiated with ultraviolet in the state in which the helical axis agrees with the normal direction of the film. This liquid crystal polymer layer functions as the seventh retardation plate RF7. The normal-directional phase difference of the seventh retardation plate RF7, which is thus obtained, is −220 nm.

The first retardation plate RF1 having the third retardation plate RF3, fourth retardation plate RF4 and eighth retardation plate RF8 is attached via an adhesive layer, such as glue, such that the first retardation plate RF1 is opposed to the liquid crystal layer 7. In addition, a polarizer plate of SRW062A (manufactured by Sumitomo Chemical Co., Ltd.) is attached as the first polarizer plate PL1 via an adhesive layer, such as glue, on the eighth retardation plate RF8. The first polarizer plate PL1 is disposed such that the absorption axis thereof intersects at right angles with the slow axis of the fourth retardation plate RF4.

On the other hand, the second retardation plate RF2 having the fifth retardation plate RF5, sixth retardation plate RF6, seventh retardation plate RF7 and ninth retardation plate RF9 is attached via an adhesive layer, such as glue, such that the seventh retardation plate RF7 is opposed to the liquid crystal layer 7. In addition, a polarizer plate of SRW062A (manufactured by Sumitomo Chemical Co., Ltd.) is attached as the second polarizer plate PL2 via an adhesive layer, such as glue, on the ninth retardation plate RF9. The second polarizer plate PL2 is disposed such that the absorption axis thereof intersects at right angles with the slow axis of the sixth retardation plate RF6.

The angle between the transmission axis of each of the first polarizer plate PL1 and second polarizer plate PL2 and the slow axis of each of the first retardation plate RF1 and second retardation plate RF2 is π/4 (rad). Protrusions 12 and slits 11 are arranged such that the orientation direction of liquid crystal molecules at the time when voltage is applied to the liquid crystal layer 7 is parallel or perpendicular to the transmission axes of the first polarizer plate PL1 and second polarizer plate PL2. The absorption axis of the second polarizer plate PL2 and the absorption axis of the first polarizer plate PL1 are disposed to intersect at right angles with each other. Further, the slow axis of the first retardation plate RF1 and the slow axis of the second retardation plate RF2 are disposed to intersect at right angles with each other.

In the liquid crystal display device with this structure, a voltage of 4.2 V (at white display time) and a voltage of 1.0 V (at black display time; this voltage is lower than a threshold voltage of liquid crystal material, and with this voltage the liquid crystal molecules remain in the vertical alignment) were applied to the liquid crystal layer 7, and the viewing angle characteristics of the contrast ratio were evaluated.

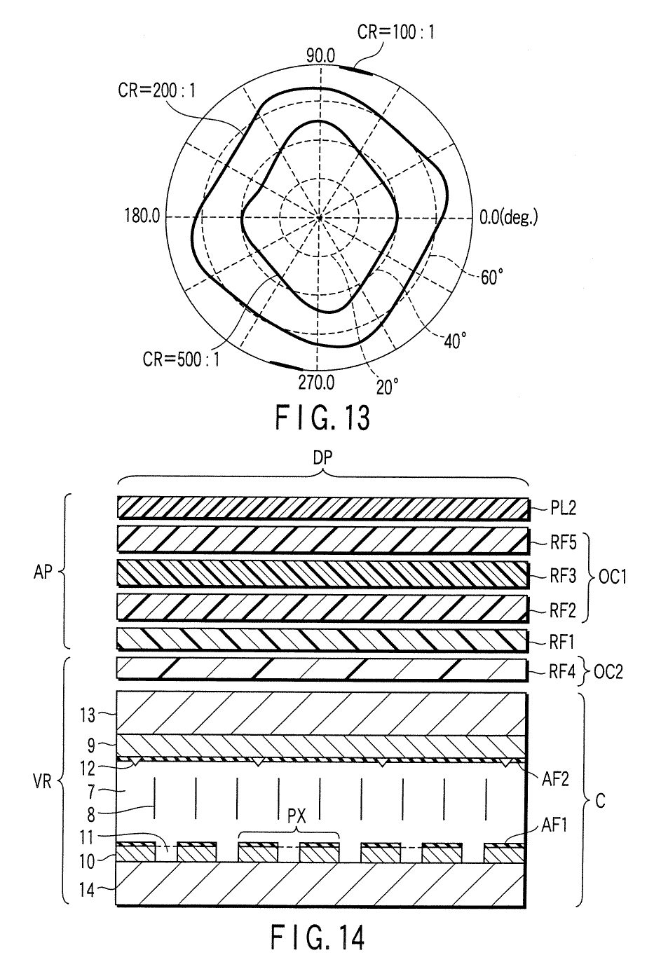

FIG. 13 shows the measurement result. It was confirmed that in almost all azimuth directions, the viewing angle with a contrast ratio of 100:1 or more was ±800 or more, and excellent viewing angle characteristics were obtained. In addition, the transmittance at 4.2 V was measured, and it was confirmed that a very high transmittance of 5.0% was obtained.

### Eighth Embodiment

The above-described fifth to seventh embodiments are directed to liquid crystal display devices in which a transmissive part is provided in at least a part of the pixel PX of the liquid crystal cell C or in at least a part of the display region DP. The invention, however, is not limited to these embodiments. The same structure as in the present invention is also applicable to, e.g. a transflective liquid crystal display device wherein a reflective layer is provided on at least a part of the pixel PX of the liquid crystal cell C, a partial-reflective liquid crystal display device wherein a reflective layer is provided in at least a part of the display region DP, and a reflective liquid crystal display device wherein a reflective layer is provided on the entire region of all pixels PX.

In the eighth embodiment, a retardation plate is added to the structure of the fourth embodiment described in connection with FIG. 9. Specifically, as shown in FIG. 14, the first optical compensation layer OC1 includes, in addition to the second retardation plate RF2 and third retardation plate RF3, an optically uniaxial fifth retardation plate (positive C-plate) RF5 having a refractive index anisotropy of nx≅ny<nz. In the other respects, the structure of the eighth embodiment is the same as that of the fourth embodiment. A retardation plate that is applicable to the fifth retardation RF5 should have a refractive index ellipsoid (nx≅ny<nz) as shown in FIG. 3. The fifth retardation plate RF5 in this example can be formed of the same material as the ninth retardation plate RF9 described with reference to FIG. 10A.

With the liquid crystal display device including the reflective part, too, the viewing angle characteristics can be improved, and the cost can be reduced, compared to the case of using the biaxial retardation plate.

Needless to say, a single liquid crystal cell C may be configured to include both the above-described transmissive part and reflective part.

As has been described in connection with each of the embodiments, the first optical compensation layer OC1 may be composed of the above-described single optical film 200. In addition, the first retardation plate RF1 and fourth retardation plate RF4 may be composed of the above-described single biaxial retardation plate BR2. The first retardation plate RF1 and second retardation plate RF2 may be composed of the above-described single optical film 500. The third retardation plate RF3 and fifth retardation plate RF5 may be composed of the above-described single optical film 600. Besides, the third retardation plate RF3 and fifth retardation plate RF5 may be composed of the above-described single uniaxial retardation plate (negative A-plate) RF11. Even in the case of using these components, the same function as the liquid crystal display device having the structure shown in FIG. 14 can be realized.

As has been described above, the present invention provides a novel structure of a liquid crystal display device. This structure aims at preventing a decrease in transmittance, which occurs when liquid crystals are schlieren-oriented or orientated in an unintentional direction in a display mode, such as a vertical alignment mode or a multi-domain vertical alignment mode, in which the phase of incident light is modulated by about ½ wavelength in the liquid crystal layer. This invention can solve such problems that the viewing angle characteristic range is narrow and the manufacturing cost of components that are used is high, in the circular-polarization-based display mode in which circularly polarized light is incident on the liquid crystal layer, in particular, in the circular-polarization-based MVA display mode.

According to the novel structure, like the conventional circular-polarization-based MVA display mode, not only high transmittance characteristics can be obtained, but also excellent contrast/viewing angle characteristics are realized. Moreover, the manufacturing cost is lower than in the circular-polarization-based MVA mode using the conventional viewing angle compensation structure.

The present invention is not limited to the above-described embodiments. At the stage of practicing the invention, various modifications and alterations may be made without departing from the spirit of the invention. Structural elements disclosed in the embodiments may properly be combined, and various inventions can be made. For example, some structural elements may be omitted from the embodiments. Moreover, structural elements in different embodiments may properly be combined.

In the optical film that is applied to the second embodiment, third embodiment, sixth embodiment and seventh embodiment, the directors of the liquid crystal polymer molecules in the first liquid crystal film and second liquid crystal film are symmetric with respect to the bonding interface. Alternatively, the optical film in which two liquid crystal films are stacked may be configured such that the directors of the liquid crystal polymer molecules in the first liquid crystal film and second liquid crystal film are symmetric with respect to the normal line to the major plane.

(Another Example of Structure of Optical Film)

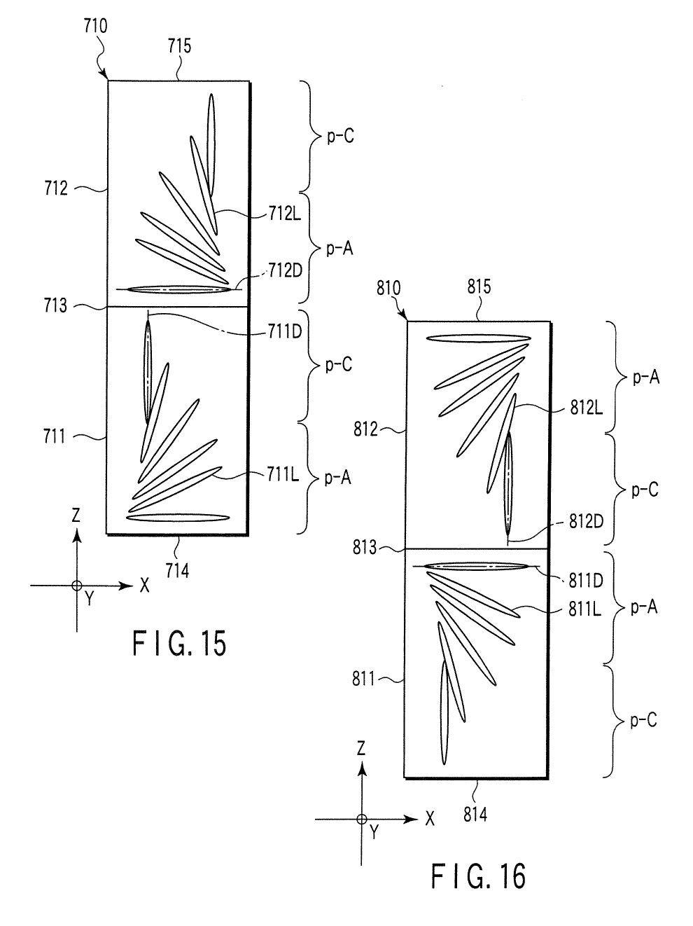

For example, as shown in FIG. 15, an optical film 710 comprises a first liquid crystal film 711 and a second liquid crystal film 712 which is stacked on the first liquid crystal film 711. The structure of each liquid crystal film is as described in connection with the second embodiment and sixth embodiment, for instance.

In the optical film 710, directors 711D and 712D of liquid crystal polymer molecules 711L and 712L in the first liquid crystal film 711 and second liquid crystal film 712 are parallel in the major plane and perpendicular to each other in a cross-sectional plane extending in the normal direction. The directors 711D and 712D of the liquid crystal polymer molecules 711L and 712L in the first liquid crystal film 711 and second liquid crystal film 712 are symmetric with respect to a normal line to the major plane.

Specifically, in the major plane defined by the X axis and Y axis, the liquid crystal polymer molecules 711L included in the first liquid crystal film 711 are not twisted and the director 711D of the liquid crystal polymer molecules 711L is oriented in one direction when the liquid crystal polymer molecules 711L are orthogonally projected. When it is assumed that the director 711D of the liquid crystal polymer molecules 711L is substantially parallel to the X axis, the liquid crystal polymer molecules 711L are, in the cross section defined by the X axis and Z axis, substantially vertical to a bonding interface 713 in the vicinity of the bonding interface 713 and are substantially parallel to the bonding interface 713 in the vicinity of an outer surface 714 of the first liquid crystal film 711. In other words, in the first liquid crystal film 711, the liquid crystal polymer molecules 711L are distributed along the normal direction Z such that the angle (tilt angle) between their director 711D and the bonding interface 713 falls within the range between 0° and 90°.

On the other hand, in the major plane defined by the X axis and Y axis, the liquid crystal polymer molecules 712L included in the second liquid crystal film 712 are not twisted and the director 712D of the liquid crystal polymer molecules 712L is oriented in one direction when the liquid crystal polymer molecules 712L are orthogonally projected. At this time, the second liquid crystal film 712 is disposed such that the director 712D of the liquid crystal polymer molecules 712L is substantially parallel to the X axis. In other words, the director 711D of the liquid crystal polymer molecules 711L and the director 712D of the liquid crystal polymer molecules 712L are parallel in the major plane.

In addition, in the cross section defined by the X axis and Z axis, the liquid crystal polymer molecules 712L are substantially parallel to the bonding interface 713 in the vicinity of the bonding interface 713 and are substantially perpendicular to the bonding interface 713 in the vicinity of an outer surface 715 of the second liquid crystal film 712. In other words, in the second liquid crystal film 712, too, the liquid crystal polymer molecules 712L are distributed along the normal direction Z such that the angle (tilt angle) between their director 712D and the bonding interface 713 falls within the range between 0° C. and 90°.

Thus, the second liquid crystal film 712 includes the liquid crystal polymer molecules 712L having the director 712D which intersects at right angles with the director 711D of the liquid crystal polymer molecules 711L included in the first liquid crystal film 711 in the cross section defined by the X axis and Z axis.

In the optical film 710, the first liquid crystal film 711 has a refractive index anisotropy of nx=ny<nz in the vicinity of the bonding interface 713 and has a refractive index anisotropy of nx>ny=nz in the vicinity of the outer surface 714 of the first liquid crystal film 711. In addition, the second liquid crystal film 712 has a refractive index anisotropy of nx>ny=nz in the vicinity of the bonding interface 713 and has a refractive index anisotropy of nx=ny<nz in the vicinity of the outer surface 715 of the second liquid crystal film 712.

Specifically, the first liquid crystal film 711 exhibits a refractive index anisotropy that is equivalent to a positive C-plate (nx=ny<nz) in the vicinity of the bonding interface 713, and exhibits a refractive index anisotropy that is equivalent to a positive A-plate (nx>ny=nz) in the vicinity of the outer surface 714. The second liquid crystal film 712 exhibits a refractive index anisotropy that is equivalent to a positive A-plate (nx>ny=nz) in the vicinity of the bonding interface 713, and exhibits a refractive index anisotropy that is equivalent to a positive C-plate (nx=ny<nz) in the vicinity of the outer surface 715.

The optical film 710 can be formed by preparing a first liquid crystal film 711 and a second liquid crystal film 712 each having a hybrid-aligned liquid crystal layer on a base film and bonding the surface of the first liquid crystal film 711 and the base film of the second liquid crystal film 712. In this optical film 710, a bonding interface is formed between the base film and the liquid crystal film surface.

Besides, as shown in FIG. 16, an optical film 810 comprises a first liquid crystal film 811 and a second liquid crystal film 812 which is stacked on the first liquid crystal film 811.

In the optical film 810, directors 811D and 812D of liquid crystal polymer molecules 811L and 812L in the first liquid crystal film 811 and second liquid crystal film 812 are parallel in the major plane and perpendicular to each other in a cross-sectional plane extending in the normal direction. The directors 811D and 812D of the liquid crystal polymer molecules 811L and 812L in the first liquid crystal film 811 and second liquid crystal film 812 are symmetric with respect to a normal line to the major plane.

Specifically, in the major plane defined by the X axis and Y axis, the liquid crystal polymer molecules 811L included in the first liquid crystal film 811 are not twisted and the director 811D of the liquid crystal polymer molecules 811L is oriented in one direction when the liquid crystal polymer molecules 811L are orthogonally projected. When it is assumed that the director 811D of the liquid crystal polymer molecules 811L is substantially parallel to the X axis, the liquid crystal polymer molecules 811L are, in the cross section defined by the X axis and Z axis, substantially parallel to a bonding interface 813 in the vicinity of the bonding interface 813 and are substantially perpendicular to the bonding interface 813 in the vicinity of an outer surface 814 of the first liquid crystal film 811. In other words, in the first liquid crystal film 811, the liquid crystal polymer molecules 811L are distributed along the normal direction Z such that the angle (tilt angle) between their director 811D and the bonding interface 813 falls within the range between 0° and 90°.

On the other hand, in the major plane defined by the X axis and Y axis, the liquid crystal polymer molecules 812L included in the second liquid crystal film 812 are not twisted and the director 812D of the liquid crystal polymer molecules 812L is oriented in one direction when the liquid crystal polymer molecules 812L are orthogonally projected. At this time, the second liquid crystal film 812 is disposed such that the director 812D of the liquid crystal polymer molecules 812L is substantially parallel to the X axis. In other words, the director 811D of the liquid crystal polymer molecules 811L and the director 812D of the liquid crystal polymer molecules 812L are parallel in the major plane.

In addition, in the cross section defined by the X axis and Z axis, the liquid crystal polymer molecules 812L are substantially perpendicular to the bonding interface 813 in the vicinity of the bonding interface 813 and are substantially parallel to the bonding interface 813 in the vicinity of an outer surface 815 of the second liquid crystal film 812. In other words, in the second liquid crystal film 812, too, the liquid crystal polymer molecules 812L are distributed along the normal direction Z such that the angle (tilt angle) between their director 812D and the bonding interface 813 falls within the range between 0° and 90°.

Thus, the second liquid crystal film 812 includes the liquid crystal polymer molecules 812L having the director 812D which intersects at right angles with the director 811D of the liquid crystal polymer molecules 811L included in the first liquid crystal film 811 in the cross section defined by the X axis and Z axis.

In the optical film 810, the first liquid crystal film 811 has a refractive index anisotropy of nx>ny nz in the vicinity of the bonding interface 813 and has a refractive index anisotropy of nx=ny<nz in the vicinity of the outer surface 814 of the first liquid crystal film 811. In addition, the second liquid crystal film 812 has a refractive index anisotropy of nx=ny<nz in the vicinity of the bonding interface 813 and has a refractive index anisotropy of nx>ny=nz in the vicinity of the outer surface 815 of the second liquid crystal film 812.

Specifically, the first liquid crystal film 811 exhibits a refractive index anisotropy that is equivalent to a positive A-plate (nx>ny=nz) in the vicinity of the bonding interface 813, and exhibits a refractive index anisotropy that is equivalent to a positive C-plate (nx=ny<nz) in the vicinity of the outer surface 814. The second liquid crystal film 812 exhibits a refractive index anisotropy that is equivalent to a positive C-plate (nx=ny<nz) in the vicinity of the bonding interface 813, and exhibits a refractive index anisotropy that is equivalent to a positive A-plate (nx>ny=nz) in the vicinity of the outer surface 815.

The optical film 810 can be formed by preparing a first liquid crystal film 811 and a second liquid crystal film 812 each having a hybrid-aligned liquid crystal layer on a base film and bonding the base film of the first liquid crystal film 811 and the surface of the second liquid crystal film 812. In this optical film 810, a bonding interface is formed between the base film and the liquid crystal film surface.

With this structure, the optical film having the same function as a biaxial retardation plate can be provided. Moreover, this optical film is less expensive than a biaxial drawn film and can be fabricated more easily.

(In-Plane Phase Difference and Normal-Directional Phase Difference of Optical Film)

In the above-described optical film, the director of liquid crystal polymer molecules is oriented in parallel to the X axis in the major plane. Assume now that in the optical film including such liquid crystal polymer molecules, the total in-lane phase difference of each respective liquid crystal film is given by (nx−ny)*d. Also assume that the total normal-directional phase difference of each respective liquid crystal film is given by (nz−ny)*d. In this case, nx≧ny, and d corresponds to the substantial thickness of each respective liquid crystal film.

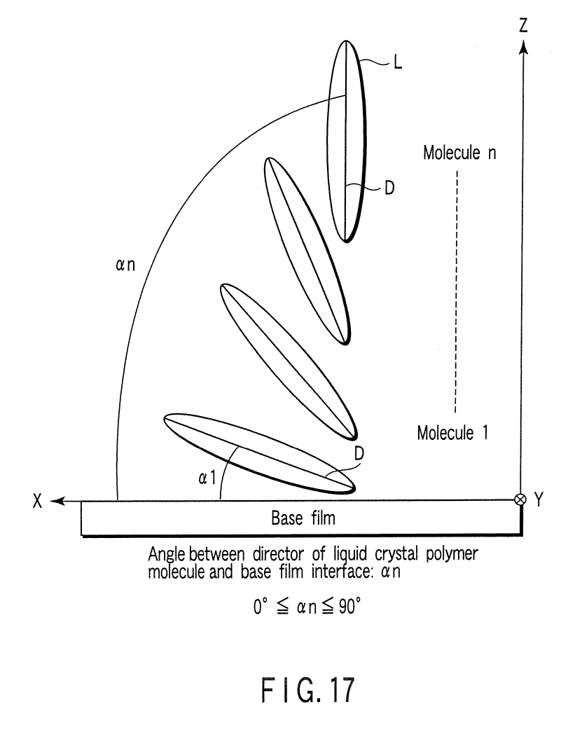

As is shown in FIG. 17, for example, each of the liquid crystal films 110 and 120 of the above-described optical film 100 is composed of liquid crystal polymer molecules L which are hybrid-aligned along the normal direction Z. Specifically, each liquid crystal film 110, 120 is composed of an n-number of liquid crystal polymer molecules L, whose angle (tilt angle) α (1, 2, . . . , n) between the director D and the base film interface falls within the range of 0° and 90°. Thus, for the purpose of convenience, when the refractive index, nx, ny, nz of each liquid crystal film 110, 120 is to be considered, the in-plane phase difference and normal-directional phase difference are defined on the basis of the refractive index, nx, ny, nz of the liquid crystal polymer molecules L which take a mean value α ave (=Σαn/n) of the tilt angle α of all liquid crystal polymer molecules.

When α ave>45°, the total refractive index anisotropy of the liquid crystal film is nz>nx>ny. When αave=45°, the total refractive index anisotropy of the liquid crystal film is nz=nx>ny. When α ave<45°, the total refractive index anisotropy of the liquid crystal film is nx>nz>ny.

In the above-described optical film, the total in-plane phase difference and normal-directional phase difference of the liquid crystal film can be adjusted to desired values by controlling the distribution of the liquid crystal polymer molecules L that constitute the liquid crystal film.

What is claimed is:

1. A liquid crystal display device which is configured such that a dot-matrix liquid crystal cell, in which a liquid crystal layer is held between two electrode-equipped substrates, is disposed between a first polarizer plate that is situated on a light source side and a second polarizer plate that is situated on an observer side, a first retardation plate is disposed between the first polarizer plate and the liquid crystal cell such that a slow axis of the first retardation plate forms an angle of about 45° with respect to an absorption axis of the first polarizer plate, and a second retardation plate is disposed between the second polarizer plate and the liquid crystal cell such that a slow axis of the second retardation plate forms an angle of about 45° with respect to an absorption axis of the second polarizer plate, the liquid crystal display device comprising:
a circular polarizer structure including the first polarizer plate and the first retardation plate;
a variable retarder structure including the liquid crystal cell; and
a circular analyzer structure including the second polarizer plate and the second retardation plate,
wherein the variable retarder structure has an optically positive normal-directional phase difference in a black display state,
each of the first retardation plate and the second retardation plate is a uniaxial ¼ wavelength plate which provides a phase difference of a ¼ wavelength between light rays of a predetermined wavelength that travel along a fast axis and the slow axis thereof,
the circular polarizer structure includes a first optical compensation layer which is disposed for optical compensation of the circular polarizer structure between the first polarizer plate and the first retardation plate, the first optical compensation layer including a uniaxial third retardation plate with a refractive index anisotropy of nx≅ny<nz and a uniaxial fourth retardation plate with a refractive index anisotropy of nx>ny≅nz, the fourth retardation plate being disposed such that a slow axis of the fourth retardation plate is substantially perpendicular to the absorption axis of the first polarizer plate,
the circular analyzer structure includes a second optical compensation layer which is disposed for optical compensation of the circular analyzer structure between the second polarizer plate and the second retardation plate, the second optical compensation layer including a uniaxial fifth retardation plate with a refractive index anisotropy of nx≅ny<nz and a uniaxial sixth retardation plate with a refractive index anisotropy of nx>ny≅nz, the sixth retardation plate being disposed such that a slow axis of the sixth retardation plate is substantially perpendicular to the absorption axis of the second polarizer plate and is substantially perpendicular to the slow axis of the fourth retardation plate, and
the variable retarder structure includes a third optical compensation layer which is disposed for optical compensation of the variable retarder structure between the first retardation plate and the second retardation plate, the third optical compensation layer including a uniaxial seventh retardation plate with a refractive index anisotropy of nx≅ny>nz.

2. The liquid crystal display device according to claim 1, wherein at least one of a) the first optical compensation layer, b) the second optical compensation layer, c) a combination of the first retardation plate and the third retardation plate and d) a combination of the second retardation plate and the fifth retardation plate is composed of a single optical film in which two liquid crystal films are stacked, each of the two liquid crystal films being configured such that liquid crystal polymer molecules, which exhibit positive uniaxiality in a major plane, are nematic-hybrid-aligned along a normal direction.

3. The liquid crystal display device according to claim 2, wherein directors of liquid crystal polymer molecules in the two liquid crystal films, which constitute the optical film, are parallel in the major plane and perpendicular to each other in a cross section along the normal direction.

4. The liquid crystal display device according to claim 3, wherein the directors of the liquid crystal polymer molecules in the two liquid crystal films, which constitute the optical film, are substantially perpendicular to a bonding interface between the two liquid crystal films in the vicinity of the bonding interface and are substantially parallel to the bonding interface in the vicinity of outer surfaces of the respective liquid crystal films.

5. The liquid crystal display device according to claim 1, wherein the first optical compensation layer further includes a uniaxial eighth retardation plate with a refractive index anisotropy of nx≅ny<nz, and
the second optical compensation layer further includes a uniaxial ninth retardation plate with a refractive index anisotropy of nx≅ny<nz.

6. The liquid crystal display device according to claim 5, wherein at least one of the first optical compensation layer and the second optical compensation layer is composed of a single optical film in which two liquid crystal films are stacked, each of the two liquid crystal films being configured such that liquid crystal polymer molecules, which exhibit positive uniaxiality in a major plane, are nematic-hybrid-aligned along a normal direction.

7. The liquid crystal display device according to claim 6, wherein directors of liquid crystal polymer molecules in the two liquid crystal films, which constitute the optical film, are parallel in the major plane and perpendicular to each other in a cross section along the normal direction.

8. The liquid crystal display device according to claim 7, wherein the directors of the liquid crystal polymer molecules in the two liquid crystal films, which constitute the optical film, are substantially parallel to a bonding interface between the two liquid crystal films in the vicinity of the bonding interface and are substantially perpendicular to the bonding interface in the vicinity of outer surfaces of the respective liquid crystal films.

9. The liquid crystal display device according to claim 5, wherein at least one of a) a combination of the first retardation plate and the third retardation plate, b) a combination of the fourth retardation plate and the eighth retardation plate, c) a combination of the second retardation plate and the fifth retardation plate and d) a combination of the sixth retardation plate and the ninth retardation plate is composed of a single optical film in which two liquid crystal films are stacked, each of the two liquid crystal films being configured such that liquid crystal polymer molecules, which exhibit positive uniaxiality in a major plane, are nematic-hybrid-aligned along a normal direction.

10. The liquid crystal display device according to claim 9, wherein directors of liquid crystal polymer molecules in the two liquid crystal films, which constitute the optical film, are parallel in the major plane and perpendicular to each other in a cross section along the normal direction.

11. The liquid crystal display device according to claim 10, wherein the directors of the liquid crystal polymer molecules in the two liquid crystal films, which constitute the optical film, are substantially perpendicular to a bonding interface between the two liquid crystal films in the vicinity of the bonding interface and are substantially parallel to the bonding interface in the vicinity of outer surfaces of the respective liquid crystal films.

12. The liquid crystal display device according to claim 1, wherein the seventh retardation plate comprises a first segment layer, which is disposed between the first retardation plate and the liquid crystal cell, and a second segment layer, which is disposed between the second retardation plate and the liquid crystal cell.

13. The liquid crystal display device according to claim 12, wherein the first segment layer is formed on the first retardation plate such that a total optical function is equivalent to a biaxial refractive index anisotropy of nx>ny>nz.

14. The liquid crystal display device according to claim 12, wherein the second segment layer is formed on the second retardation plate such that a total optical function is equivalent to a biaxial refractive index anisotropy of nx>ny>nz.

15. The liquid crystal display device according to claim 1, wherein the liquid crystal cell has a vertical alignment mode in which liquid crystal molecules in a pixel are aligned substantially vertical to a major surface of the substrate in a voltage-off state.

16. The liquid crystal display device according to claim 15, wherein the liquid crystal cell has a multi-domain vertical alignment mode in which liquid crystal molecules in the pixel are controlled and oriented in at least two directions in a voltage-on state.

17. The liquid crystal display device according to claim 15, wherein such a domain is formed that an orientation direction of liquid crystal molecules in the pixel in a voltage-on state is substantially parallel to the absorption axis or a transmission axis of the first polarizer plate in at least half an opening region of each pixel.

18. The liquid crystal display device according to claim 1, wherein the third retardation plate and the fifth retardation plate are formed of a nematic liquid crystal polymer having a normal-directional optical axis.

19. A liquid crystal display device which is configured such that a first retardation plate is disposed between a dot-matrix liquid crystal cell, in which a liquid crystal layer is held between two electrode-equipped substrates and a reflective layer is provided on each of pixels, and a polarizer plate such that a slow axis of the first retardation plate forms an angle of about 45° with respect to an absorption axis of the polarizer plate, the liquid crystal display device comprising:
a circular polarizer/analyzer structure including the polarizer plate and the first retardation plate; and
a variable retarder structure including the liquid crystal cell,
wherein the variable retarder structure has an optically positive normal-directional phase difference in a black display state,
the first retardation plate is a uniaxial ¼ wavelength plate which provides a phase difference of a ¼ wavelength between light rays of a predetermined wavelength that travel along a fast axis and the slow axis thereof,
the circular polarizer/analyzer structure includes a first optical compensation layer which is disposed for optical compensation of the circular polarizer/analyzer structure between the polarizer plate and the first retardation plate, the first optical compensation layer including a uniaxial second retardation plate with a refractive index anisotropy of nx≅ny<nz and a uniaxial third retardation plate with a refractive index anisotropy of nx>ny≅nz, the third retardation plate being disposed such that a slow axis of the third retardation plate is substantially perpendicular to the absorption axis of the polarizer plate, and
the variable retarder structure includes a second optical compensation layer which is disposed for optical compensation of the variable retarder structure between the first retardation plate and the liquid crystal cell, the second optical compensation layer including a fourth retardation plate with a refractive index anisotropy of nx≅ny>nz.

20. The liquid crystal display device according to claim 19, wherein the first optical compensation layer further includes a uniaxial fifth retardation plate with a refractive index anisotropy of nx≅ny<nz.
